(19) United States
(12) Patent Application Publication
(10) Pub. No.: US 2015/0272804 A1
(43) Pub. Date: Oct. 1, 2015

(54) METHODS AND APPARATUSES FOR INCREASING MUCOCILIARY CLEARANCE

(71) Applicant: VENTAERX, INC., Sunnyvale, CA (US)

(72) Inventor: YIP-FONG CHIA, Sunnyvale, CA (US)

(21) Appl. No.: 14/676,718

(22) Filed: Apr. 1, 2015

Related U.S. Application Data
(63) Continuation of application No. PCT/US2013/062169, filed on Sep. 27, 2013.
(60) Provisional application No. 61/778,090, filed on Mar. 12, 2013.
(60) Provisional application No. 61/758,125, filed on Jan. 29, 2013.
(60) Provisional application No. 61/709,806, filed on Oct. 4, 2012.

(51) Int. Cl. A61H 1/00

(52) U.S. Cl. CPC A61H 1/005

(57) ABSTRACT

The present invention provides non-invasive methods and apparatuses for increasing mucociliary clearance (MCC) of a subject to prevent, treat, or improve MCC in conditions such as Eustachian tube dysfunction, otitis media, and diseases of the upper and/or lower respiratory tracts. As described herein, the methods and apparatuses of the present invention increase MCC by applying non-invasive external movement/force to a subject to generate internal mechanical oscillating shear stress in the subject for prophylactic or therapeutic use in subjects at risk of developing or having a condition of the upper and lower respiratory system, Eustachian tube, or middle ear that is caused by impairment of the MCC system.

### CROSS-REFERENCES TO RELATED APPLICATIONS

This application is a continuation of PCT/US2013/062169 filed Sep. 27, 2013, which application claims priority to U.S. Provisional Patent Application No. 61/709,806, filed Oct. 4, 2012, U.S. Provisional Patent Application No. 61/758,125, filed Jan. 29, 2013, and U.S. Provisional Patent Application No. 61/778,090, filed Mar. 12, 2013, the disclosures of which are hereby incorporated by reference in their entirety for all purposes.

### FIELD OF THE INVENTION

The present invention relates to the technical field of increasing mucociliary clearance to treat Eustachian tube dysfunction, otitis media, and diseases of the upper and lower respiratory tracts.

### BACKGROUND OF THE INVENTION

The respiratory system, consisting of the upper and lower respiratory systems, supplies the blood with oxygen and removes carbon dioxide from the body. As air is inhaled through the nose, the air is warmed by the nasal and sinus cavities before flowing into the trachea and down to the bronchi and bronchioles and eventually to the aveoli in the lungs, where gas exchange between the air and blood occurs. Connected to the upper respiratory system, the Eustachian tube provides the middle ear access to the external atmosphere via the nasopharynx. The Eustachian tube is normally closed to protect the middle ear from sound waves and contaminants, but it opens intermittently to allow the middle ear pressure to equalize with atmospheric pressure and provides a path for drainage of mucus secreted in the middle ear.

Mucociliary clearance (MCC) is an innate defense mechanism that protects the respiratory system, Eustachian tube and middle ear from inhaled microbial pathogens, and biochemical and environmental pollutants. The MCC mechanism consists of three principal components: (1) mucins, which are glycoproteins secreted by goblet cells that are key components of mucus; (2) an ion transport mechanism that maintains hydration of the periciliary liquid and mucus layers (collectively called airway surface liquid); and (3) cilia lining the mucosa that beat in a coordinated manner. The respiratory tract, Eustachian tube and middle ear are lined with ciliated epithelial cells interspersed with goblet cells. The cilia are bathed in a layer of watery periciliary liquid. Sitting above the periciliary liquid is a viscoelastic mucus layer which traps inhaled contaminants. The periciliary liquid prevents intrusion of the mucus layer on the cilia and provides lubrication needed for the cilia to beat in a coordinated manner and at an optimum beat frequency. The beating cilia propel the mucus with entrapped contaminants towards the pharynx to be swallowed into the gastrointestinal tract or expelled through the mouth.

Impairment of MCC mechanisms is understood to underlie a number of diseases and conditions of the upper and lower respiratory systems, Eustachian tube, and/or middle ear. Impairment of the MCC system usually begins with inflammation which triggers excess mucus secretion. This leads to dehydration of the airway surface liquid, which then causes cilia to collapse, which results in mucus accumulation and eventually infection. If MCC is not restored, it results in a vicious cycle of recurrent and worsening episodes of inflammation, mucus accumulation and infection, which can result in permanent cellular damage. Impaired MCC is found in devastating respiratory diseases such as chronic obstructive pulmonary disease (including chronic bronchitis and emphysema), asthma, cystic fibrosis and primary cilia dyskinesia. It is also found in upper respiratory conditions such as chronic sinusitis, allergic and non-allergic rhinitis, Eustachian tube dysfunction, and otitis media where quality of life is significantly impacted. While there are apparatuses and methods for treating these diseases and conditions, they often come with drawbacks, and rather than directly restoring MCC, most current treatments only treat the symptoms.

For example, therapeutic agents and medications, including anti-inflammatory agents, mucolytics, bronchiodilators, antibiotics, etc., are commonly prescribed and/or available over-the-counter for the treatment of respiratory diseases and conditions. However, these therapeutic agents and medications are designed to treat the symptoms. None of these therapeutics directly restores MCC and, as such, are not completely effective in preventing progression of severe respiratory diseases. There are limited device options for airway clearance, and existing devices targeting the lower respiratory system are limited to usage by a small patient population. As such, there is a need for non-invasive methods and apparatuses to treat diseases and conditions of the upper and lower respiratory systems, Eustachian tube and middle ear by directly improving MCC without the undesired side-effects and inefficiencies that often accompany current treatments. The present invention satisfies this need and provides related advantages as well.

### BRIEF SUMMARY OF THE INVENTION

The present invention provides non-invasive methods and apparatuses for increasing mucociliary clearance (MCC) of a subject to prevent, treat, or improve MCC in conditions such as Eustachian tube dysfunction, otitis media, and diseases of the upper and/or lower respiratory tracts. As described herein, the methods and apparatuses of the present invention increase MCC by applying non-invasive external movement/force to a subject to generate internal mechanical oscillating shear stress in the subject for prophylactic or therapeutic use in subjects at risk of developing or having a condition of the upper and lower respiratory system, Eustachian tube, or middle ear that is caused by impairment of the MCC system.

In one aspect, the present invention provides a method for increasing mucociliary clearance of a subject, the method comprising:
providing an oscillating lateral motion to the subject positioned in a supine position on a flat surface, wherein the oscillating lateral motion is applied at a frequency of about 60 to about 200 cycles per minute; and
providing the oscillating lateral motion for a time period of about 2 to about 60 minutes.

In some embodiments, the method of the invention clears mucus in at least one member selected from the group consisting of the Eustachian tube, middle ear, sinus cavity, nasal cavity, trachea, bronchi, bronchioles, and combinations thereof.

In other embodiments, the oscillating lateral motion is applied to a part of each leg of the subject. In certain instances, the oscillating lateral motion is applied to each hip, upper leg, thigh, knee, lower leg, calf, ankle, and/or foot of the subject.

In some embodiments, the oscillating lateral motion is applied at a frequency of about 90 to about 180 cycles per minute (CPM), e.g., about 110 to about 160 CPM, about 130 to about 150 CPM, or about 140 CPM. In other embodiments, the oscillating lateral motion is applied for a time period of about 10 to about 50 minutes, e.g., about 20 to about 45 minutes or about 25 to about 35 minutes.

In certain embodiments, the oscillating lateral motion provides a side-to-side twisting motion to the hips, torso, and/or head of the subject. In other embodiments, the oscillating lateral motion translates into a lateral displacement of about 5 mm to about 20 mm (e.g., about 8 mm to about 14 mm) of the forehead of the subject. In yet other embodiments, the oscillating lateral motion translates into a longitudinal displacement of about 0.5 mm to about 5 mm (e.g., about 1 mm to about 2 mm) of the forehead of the subject.

In some embodiments, the method further comprises a health care provider performing an assessment of the amount of mucociliary clearance after expiry of the time period. In certain instances, the amount of mucociliary clearance is assessed using a tympanometer.

In certain embodiments, the oscillating lateral motion generates oscillating shear stress in the subject's respiratory system. In particular embodiments, the oscillating lateral motion that is applied to the legs and/or torso of the subject is transmitted to the upper body, which creates oscillating shear stress in the epithelial surfaces of the lower and upper respiratory tract, middle ear, and Eustachian tube. In some instances, the oscillating lateral motion generates oscillating shear stress in a range of about 0.01 to about 10 dynes per cm², e.g., about 0.1 to about 5 dynes per cm².

In another aspect, the present invention provides a non-invasive method for preventing or treating conditions of the upper and lower respiratory system, Eustachian tube, or middle ear. Non-limiting examples of conditions include Eustachian tube dysfunction; otitis media; primary ciliary dyskinesia; cystic fibrosis; conditions of the upper respiratory tract such as, e.g., allergic rhinitis, non-allergic rhinitis, and sinusitis; conditions of the lower respiratory tract such as, e.g., chronic bronchitis, emphysema, and asthma; and combinations thereof.

The methods of the present invention can be performed with an apparatus as described herein or with any apparatus or device capable of providing an oscillating lateral motion to the subject positioned in a supine position on a flat surface at a frequency of about 60 to about 200 cycles per minute and for a time period of about 2 to about 60 minutes.

Other objects, features, and advantages of the present invention will be apparent to one of skill in the art from the following detailed description and figures.

### BRIEF DESCRIPTION OF THE DRAWINGS

FIG. 1 is an illustration of the movement directions of the human body.

FIG. 2 is an illustration of the anatomy of the middle ear and Eustachian tube.

FIG. 3 is an illustration the epithelium of the respiratory tract and the cells that form the mucociliary clearance system.

FIG. 4 is an illustration of an exemplary apparatus in accordance with an embodiment of the invention.

FIGS. 5A-C illustrate other embodiments of an exemplary apparatus of the invention.

FIG. 6A illustrates the change in airway surface liquid (ASL) height between pre-shear and post-shear cultures immediately after cultures were removed from shear stress at frequencies of 28, 70 and 140 cycles per minute (CPM) compared to sham cultures.

FIG. 6B illustrates the height of airway surface liquid (ASL) in cultures over time after cultures were removed from oscillating shear stress at 28, 70 and 140 CPM compared to sham cultures.

FIG. 7 illustrates a comparison of the steady state ATP concentrations in the airway surface liquid (ASL) of cultures subjected to shear stress at frequencies of 28, 70 and 140 CPM compared to sham cultures.

FIG. 8A illustrates the change in cilia beat frequency (CBF) between pre-shear and post-shear cultures immediately after cultures were removed from shear stress at frequencies of 28, 70 and 140 CPM compared to sham cultures.

FIG. 8B illustrates cilia beat frequency (CBF) over time after cultures were removed from oscillating shear stress at 28, 70 and 140 CPM compared to sham cultures.

FIG. 9 illustrates the middle ear pressure of the right ear before and after treatment at 140 CPM for 30 minutes for Subject A.

FIGS. 10A-B illustrate the middle ear pressure for Subject B before and after treatment at 140 CPM for 30 minutes for (FIG. 10A) left ear and (FIG. 10B) right ear.

FIGS. 11A-B illustrate the middle ear pressure for Subject C before and after treatment at 140 CPM for 15 minutes for (FIG. 10A) left ear and (FIG. 10B) right ear.

FIG. 12 illustrates the mean middle ear pressure for Subjects A, B, and C before and after treatment.

FIGS. 13A-B illustrate the displacement over time in the forehead of an individual using a device as described herein to generate oscillating motion along the respiratory tract. FIG. 13A illustrates forehead displacement in the side-to-side direction (lateral displacement). FIG. 13B illustrates forehead displacement in the head-to-toe direction (longitudinal displacement).

### DETAILED DESCRIPTION OF THE INVENTION

### I. Introduction

The present invention provides non-invasive methods and apparatuses for increasing mucociliary clearance (MCC) of a subject. In some aspects, the present invention is useful for preventing, treating, or improving MCC in conditions such as Eustachian tube dysfunction, otitis media, and diseases of the upper and/or lower respiratory tracts.

MCC is an innate defense mechanism that protects the lungs from inhaled pathogens and pollutants. The MCC mechanism consists of three components: mucin secretion by goblet cells; ion transport mechanism that maintains adequate hydration of the airway surface liquid (ASL); and cilia lining the airway surface that beat synchronously to move mucus towards the pharynx to be swallowed or coughed out. The MCC system is provided by the epithelia, which consists of ciliated cells interspersed with goblet cells lining the middle ear, Eustachian tube, nasal and sinus cavities, trachea, bronchi and bronchioles. In diseases such as cystic fibrosis (CF), chronic obstructive pulmonary obstruction (COPD), chronic rhinitis and otitis media, MCC is impaired.

Current mucus clearance devices utilize oscillating shear stress at very high frequencies of 8-30 Hz. Most of these devices are intended to generate high shear stress sufficient to loosen any adhering viscoelastic mucus and the loosened mucus is then removed by coughing. Some of these high frequency devices cannot be tolerated by young children or individuals weakened by diseases of the respiratory tract, thereby making them unsuitable for use by some individuals in need of improved MCC. The present methods and apparatuses overcome these limitations and provide additional advantages as well by increasing MCC using oscillating shear stress at much lower frequencies of about 1-3 Hz, e.g., about 60-200 cycles per minute (CPM), which are well tolerated by all individuals. For instance, an exemplary apparatus which provided oscillating shear stress at much lower frequencies of about 60-200 CPM (e.g., about 140 CPM) was sufficient to cause the Eustachian tube of subjects with otitis media to open intermittently and allowed equilibration of middle ear pressure and/or drainage.

As such, the present invention is based, in part, upon the surprising discovery that MCC is increased when the mechanical oscillating shear stress created by the methods and apparatuses described herein at frequencies of about 60 and about 200 CPM (e.g., about 140 CPM) stimulates extracellular adenosine triphosphate (ATP) release in the epithelial cells lining the mucosa of the respiratory tract and Eustachian tube of a subject. This increase in extracellular ATP increases the beat frequency of cilia lining the mucosa, increases ion transport which increases hydration of the airway surface liquid, and increases secretion of mucins, which collectively enhances the ability of the MCC system to propel the viscoelastic mucus containing trapped contaminants towards the pharynx to be swallowed into the gastrointestinal tract and/or expelled through the mouth. The methods and apparatuses of the present invention thus stimulate all three components of the MCC system through the mechanical delivery of oscillating shear stress to the entire respiratory system.

### II. Definitions

The term “clearing the Eustachian tube” as used herein refers to opening the Eustachian tube briefly to allow equalization of the air pressure in the middle ear to the air pressure of the external atmosphere and drainage of fluids from the middle ear.

As used herein, the term “part of each leg” or “part of a leg” refers to a separate part of a leg of the subject. The parts include the hips, upper leg or the thigh, the knee, the lower leg or the calf, the ankle, and the feet.

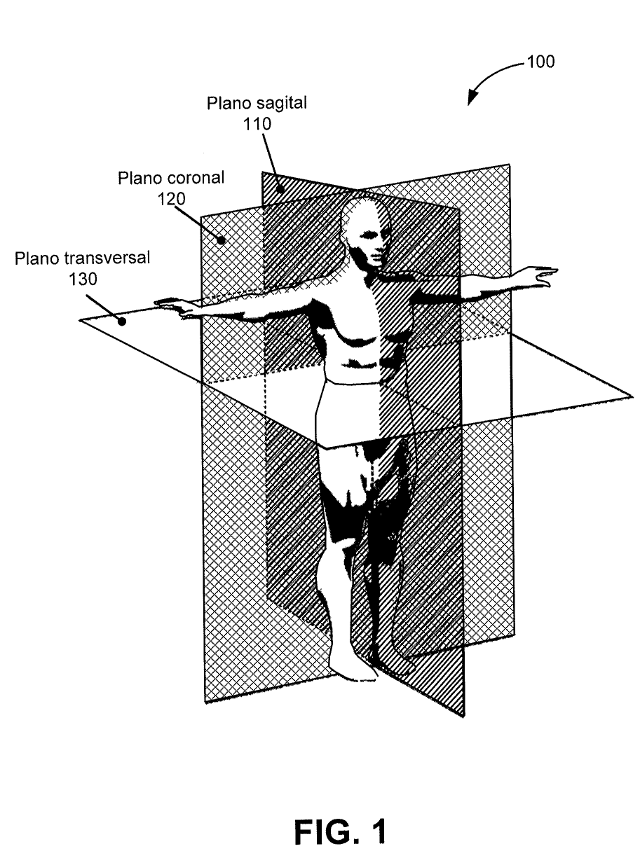

The term “lateral motion” refers to movement within the coronal or frontal plane of the human body. FIG. 1 provides an illustration depicting the various planes used to define motion for the human body, including the coronal plane (“plano coronal”). The coronal plane or frontal plane is readily understood by those of ordinary skill in the art as the plane that divides the body lengthwise, anterior from posterior. When the body is divided by the coronal plane, the face is separated from the back of the head, the chest from the back, the palms from the back of the hands, and the shins from the calves. As used herein, lateral motion to a portion of the legs of a subject refers to the side-to-side motion of the portion of the legs within the coronal or frontal plane. As non-limiting examples, lateral motion of a subject's ankles refers to the side-to-side motion of the ankles, and lateral motion of a subject's knees refers to the side-to-side motion of the knees.

As used herein, the term “side-to-side twisting motion” refers to the motion resulting at the hips, thorax, neck, and head regions of a subject where the aforementioned anatomical parts experience a side-to-side motion in the coronal or frontal plane occurring simultaneously and in combination with a twisting motion in the coronal plane and the transverse plane. As shown in FIG. 1, the transverse plane (“plano transversal”), also known as the horizontal plane, the axial plane, or the transaxial plane, is readily understood by those of ordinary skill in the art as an imaginary plane that divides the body into superior and inferior parts. The transverse plane is perpendicular to the coronal and sagital planes. As described herein, “a twisting motion” refers to a slight turning of the hips, thorax, neck and head regions of a subject in the transverse plane and coronal plane.

As used herein, the term “lateral displacement” refers to the spatial displacement of an anatomical part of the body from its initial resting position in the side-to-side direction within the coronal or frontal plane. Therefore, the “lateral displacement” of a portion of a subject's body part such as the leg or forehead refers to the distance within the coronal or frontal plane that the referenced portion of the body part is displaced. As a non-limiting example, this distance can be measured from the beginning location of a point on the outer surface of a portion of a body part to the furthest outward location of the same point resulting from the lateral displacement of the body part. As described herein, the oscillating lateral motion applied to a subject in accordance with the methods and apparatuses of the present invention translates into a lateral displacement of the forehead of the subject of a given distance.

The term “longitudinal displacement” as used herein refers to the spatial displacement of an anatomical part of the body from its initial resting position in the head-to-toe direction. As such, the “longitudinal displacement” of a portion of a subject's body part such as the leg or forehead refers to the distance within the head-to-toe direction that the referenced portion of the body part is displaced. As a non-limiting example, this distance can be measured from the beginning location of a point on the outer surface of a portion of the subject's body part to the furthest outward location of the same point resulting from the longitudinal displacement of the body part. As described herein, the oscillating lateral motion applied to a subject in accordance with the methods and apparatuses of the invention translates into a longitudinal displacement of the forehead of the subject of a given distance.

The term “subject,” “patient,” or “individual” typically refers to humans, but also to other animals including, e.g., other primates (e.g., monkeys), rodents (e.g., rats, mice), canines (e.g., dogs), felines (e.g., cats), equines (e.g., horses), ovines, porcines, and the like.

### III. Description of the Embodiments

The present invention provides non-invasive methods and apparatuses for increasing mucociliary clearance (MCC) of a subject to prevent, treat, or improve MCC in conditions such as Eustachian tube dysfunction, otitis media, and diseases of the upper and/or lower respiratory tracts. Without being bound to any particular theory, the present invention is based upon the discovery that the mechanical oscillating shear stress created by the methods and apparatuses described herein stimulates extracellular ATP release in the epithelial cells lining the mucosa of the respiratory tract and Eustachian tube of a subject. This increase in extracellular ATP levels increases the beat frequency of cilia lining the mucosa, increases ion transport which increases hydration of the airway surface liquid, and increases secretion of mucins, which collectively enhances the ability of the MCC system to propel the viscoelastic mucus containing trapped contaminants towards the pharynx to be swallowed into the gastrointestinal tract and/or expelled through the mouth. As such, the methods and apparatuses of the invention increase MCC by applying non-invasive external movement and/or force to a subject to generate internal mechanical oscillating shear stress in the subject for prophylactic or therapeutic use in subjects at risk of developing or having a condition of the upper and lower respiratory system, Eustachian tube, or middle ear that is caused by impairment of the MCC system.

In one aspect, the present invention provides a method for increasing mucociliary clearance (MCC) of a subject, the method comprising:
providing an oscillating lateral motion to the subject positioned in a supine position on a flat surface, wherein the oscillating lateral motion is applied at a frequency of about 60 to about 200 cycles per minute; and
providing the oscillating lateral motion for a time period of about 2 to about 60 minutes.

In some embodiments, the method of the invention clears mucus in at least one member selected from the group consisting of the Eustachian tube, middle ear, sinus cavity, nasal cavity, trachea, bronchi, bronchioles, and combinations thereof.

In other embodiments, the oscillating lateral motion is applied to a part of each leg of the subject. In certain instances, the oscillating lateral motion is applied to each ankle of each leg of the subject. In other instances, the oscillating lateral motion is applied to each knee of each leg of the subject. In yet other instances, the oscillating lateral motion is applied to each calf of each leg of the subject. In further instances, the oscillating lateral motion is applied to each thigh of each leg of the subject. In other instances, the oscillating lateral motion is applied to the hips of the subject. In yet other instances, the oscillating lateral motion is applied to the torso of the subject. In some instances, the oscillating lateral motion is applied to one or more parts of each leg (e.g., the hip, upper leg, thigh, knee, lower leg, calf, ankle, and/or foot) of the subject. In other instances, the oscillating lateral motion is applied to a part of each leg and the torso of the subject. In preferred embodiments, the subject is a human (e.g., child or adult).

In some embodiments, the oscillating lateral motion is applied at a frequency of about 90 to about 180 cycles per minute (CPM), e.g., about 110 to about 160 CPM, about 120 to about 160 CPM, about 130 to about 150 CPM, or about 60, 70, 80, 90, 100, 110, 120, 130, 135, 140, 145, 150, 160, 170, 180, 190, or 200 CPM. In other embodiments, the oscillating lateral motion is applied for a time period of about 10 to about 50 minutes, e.g., about 20 to about 45 minutes, about 25 to about 35 minutes, or about 2, 5, 10, 15, 20, 25, 30, 35, 40, 45, 50, 55, or 60 minutes.

In certain embodiments, the oscillating lateral motion provides a side-to-side twisting motion to the hips, torso, and/or head of the subject. In other embodiments, the oscillating lateral motion translates into a lateral displacement of about 5 mm to about 20 mm (e.g., about 7.5 mm to about 15 mm, about 8 mm to about 14 mm, about 8 mm to about 12 mm, about 9 mm to about 10 mm, or about 5, 6, 7, 8, 9, 10, 11, 12, 13, 14, 15, 16, 17, 18, 19, or 20 mm) of the forehead of the subject. In yet other embodiments, the oscillating lateral motion translates into a longitudinal displacement of about 0.5 mm to about 5 mm (e.g., about 0.5 mm to about 3 mm, about 0.5 mm to about 2 mm, about 1 mm to about 2 mm, or about 0.5, 0.75, 1, 1.5, 2, 2.5, 3, 3.5, 4, 4.5, or 5 mm) of the forehead of the subject.

In some embodiments, the method further comprises a health care provider performing an assessment of the amount of mucociliary clearance after expiry of the time period. In certain instances, the amount of mucociliary clearance is assessed using a tympanometer.

In other embodiments, the flat surface comprises a floor, a mattress, a pad, a table top, a mat, a rug, and the like.

In certain embodiments, the oscillating lateral motion generates oscillating shear stress in the subject's respiratory system. In particular embodiments, the oscillating lateral motion that is applied to the legs and/or torso of the subject is transmitted to the upper body, which creates oscillating shear stress in the epithelial surfaces of the lower and upper respiratory tract, middle ear and Eustachian tube. As described above, the mechanical oscillating shear stress stimulates extracellular ATP release in epithelial cells, which increases the beat frequency of mucosal cilia, the hydration of the airway surface liquid, and the secretion of mucins, which collectively restores the function of the mucociliary clearance system. In some instances, the oscillating lateral motion generates oscillating shear stress in a range of about 0.01 to about 10 dynes per cm², e.g., about 0.05 to about 8 dynes per cm², about 0.05 to about 5 dynes per cm², about 0.1 to about 5 dynes per cm², about 0.5 to about 5 dynes per cm², about 0.05 to about 2 dynes per cm², or about 0.01, 0.05, 0.1, 0.5, 1, 2, 3, 4, 5, 6, 7, 8, 9, or 10 dynes per cm².

In another aspect, the present invention provides a non-invasive method for preventing or treating conditions of the upper and lower respiratory system, Eustachian tube, or middle ear. Non-limiting examples of conditions include Eustachian tube dysfunction; otitis media; primary ciliary dyskinesia; cystic fibrosis; conditions of the upper respiratory tract such as, e.g., allergic rhinitis, non-allergic rhinitis, and sinusitis; conditions of the lower respiratory tract such as, e.g., chronic bronchitis, emphysema, and asthma; and combinations thereof.

The methods of the present invention can be performed with an apparatus as described herein or with any apparatus or device capable of providing an oscillating lateral motion to the subject positioned in a supine position on a flat surface at a frequency of about 60 to about 200 cycles per minute and for a time period of about 2 to about 60 minutes.

In a related aspect, the methods and apparatuses of the present invention are suitable for veterinary use in a non-human subject such as a dog or cat, e.g., for increasing MCC of the non-human subject to prevent or treat a breathing problem.

In such aspects, the present invention provides a method for increasing mucociliary clearance (MCC) of a non-human subject, the method comprising:
providing an oscillating lateral motion to the non-human subject positioned in a supine position on a flat surface, wherein the oscillating lateral motion is applied at a frequency of about 60 to about 200 cycles per minute; and
providing the oscillating lateral motion for a time period of about 2 to about 60 minutes.

In certain embodiments, the oscillating lateral motion is applied to the torso or trunk of the non-human subject. As a non-limiting example, a non-human subject such as a dog or cat is placed on its stomach or side on the flat surface. In other embodiments, the oscillating lateral motion is applied at a range of frequencies and time periods as set forth above.

In another related aspect, the methods and apparatuses of the present invention are used to treat dry eye (i.e., keratoconjunctivitis sicca) in a subject, the method comprising:
providing an oscillating lateral motion to the subject positioned in a supine position on a flat surface, wherein the oscillating lateral motion is applied at a frequency of about 60 to about 200 cycles per minute; and
providing the oscillating lateral motion for a time period of about 2 to about 60 minutes.

In certain embodiments, the oscillating lateral motion is applied to a part of each leg and/or torso of the subject while the subject is lying on the flat surface as described above. In other embodiments, the oscillating lateral motion is applied at a range of frequencies and time periods as set forth above. In particular embodiments, the methods and apparatuses described herein stimulate or increase tear production in the eyes of the subject such that there is increased tear production during the time period.

### IV. Mucociliary Clearance System

Mucociliary clearance (MCC) is an innate defense mechanism that protects the respiratory system, Eustachian tube, and middle ear from inhaled microbial pathogens, and biochemical and environmental pollutants. The MCC mechanism consists of three principal components: (1) mucins, which are glycoproteins secreted by goblet cells that are key mucus components; (2) an ion transport mechanism that maintains hydration of the periciliary liquid and mucus layers (collectively called airway surface liquid); and (3) cilia lining the mucosa that beat in a coordinated manner. The respiratory tract, Eustachian tube, and middle ear are lined with ciliated epithelial cells interspersed with goblet cells. The cilia are bathed in a layer of watery periciliary liquid. Sitting above the periciliary liquid is a viscoelastic mucus layer which traps inhaled contaminants. The periciliary liquid prevents intrusion of the mucus layer on the cilia and provides lubrication needed for the cilia to beat in a coordinated manner and at an optimum beat frequency. The beating cilia propel the mucus containing the entrapped contaminants towards the pharynx to be swallowed into the gastrointestinal tract or expelled through the mouth.

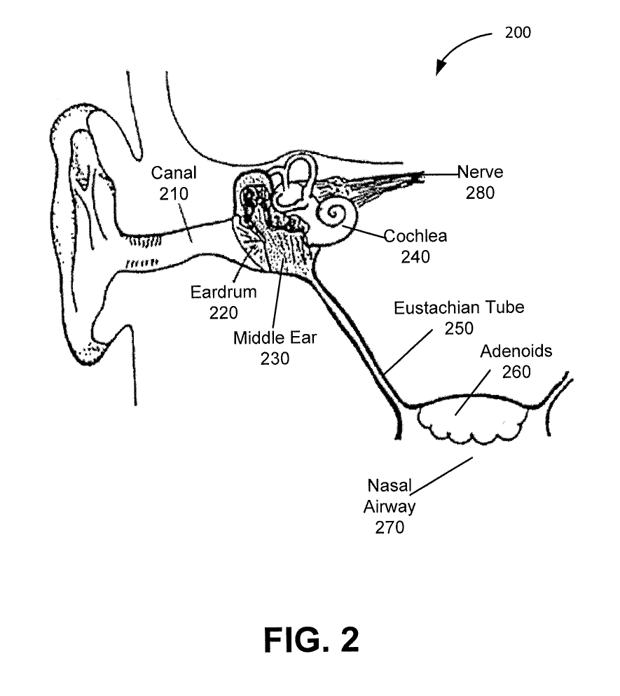

The respiratory system includes the nose, mouth, pharynx, larynx, trachea, bronchi, bronchioles, and lungs. These organs are involved in the interchange of gases. The upper respiratory tract includes the nose, nasal cavity, paranasal sinuses and pharynx. The paranasal sinuses are a connected system of hollow cavities in the skull. The sinus cavities include the maxillary sinuses (in the cheekbones), frontal sinuses (in the forehead), ethmoid sinuses (between the eyes), and sphenoid sinuses (behind the nasal cavity). The lower respiratory tract includes the larynx, trachea, bronchi, bronchioles, and aveoli of the lungs. The Eustachian tube connects the middle ear and the nasopharynx, the uppermost part of the pharynx. FIG. 2 illustrates the anatomy of the middle ear and Eustachian tube.

The function of the respiratory system is to supply the blood with oxygen and remove carbon dioxide. As air is inhaled through the nose, the air is warmed by the nasal and sinus cavities before flowing into the trachea and down to the bronchi and eventually to the aveoli in the lungs, where gas exchange between air and blood occurs. The respiratory tract is also the path for expelling carbon dioxide. Carbon dioxide, a waste by-product carried by the blood, is released into the aveoli. The function of the Eustachian tube is to provide the middle ear access to the external atmosphere, thereby allowing the middle ear to equalize its air pressure with the atmospheric air pressure; to provide drainage of fluids that accumulate in the middle ear; and to protect the middle ear from sound waves and contaminants.

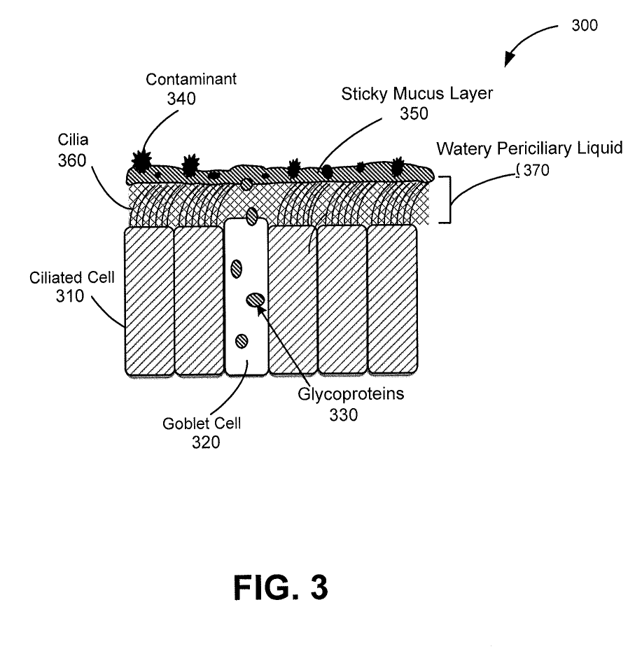

As depicted in FIG. 3, epithelia (300) consisting of ciliated cells (310) interspersed with goblet cells (320) that secrete glycoproteins (330) such as mucins form the lining of the middle ear, Eustachian tube, and the upper and lower respiratory tract including the trachea, bronchi, bronchioles, nasal cavities, and sinus cavities. Inhaled particles and contaminants (340) are trapped in the sticky mucus layer (350) of the respiratory tract. The beating cilia (360), which are bathed in a layer of watery periciliary liquid (370), propel the viscoelastic sticky mucus upper layer containing trapped contaminants towards the pharynx to be swallowed into the gastrointestinal tract or expelled through the mouth.

The MCC system plays a critical role in the proper functioning of the lower and upper respiratory systems, middle ear, and Eustachian tube. Impairment of MCC can be due to environmental damage, chronic inflammation or infection, or inherited genetic mutations that cause one or more components of the MCC mechanism to not function properly. For example, exposure to occupational or environmental irritants such as ozone, nitrogen dioxide, fumes from chemicals (e.g., sulfur dioxide, hydrogen sulfide, bromine, chlorine, strong acids, ammonia), certain organic solvents, and dust (e.g., coal dust and grain dust) can damage or impair ciliated epithelia cells, contributing to the development and/or worsening of lung diseases and other disease states or conditions.

Extracellular nucleotides, adenosine triphosphate (ATP) and uridine triphosphate (UTP) are important regulators of mucus clearance due to their ability to stimulate fluid secretion, mucus hydration and ciliary beat frequency (B. Button et al., Resp Physiol Neurobiol., 163(1-3), 189-201 (2008)). The heights of the periciliary liquid and mucus layers are regulated by extracellular ATP (Tarran et al., J Biol Chem., 280(42), 35751-59, 2005). The layer of periciliary liquid prevents intrusion of the mucus layer on the cilia and provides the lubrication required for the cilia to maintain a normal ciliary beat frequency. Dehydration of the mucus layer and depletion in the height of the periciliary liquid layer can lead to cilia collapse, impaired MCC, and infection (Davis and Lazarowski, Respir Physiol Neurobiol., 163(1-3), 208-213 (2008)).

The stimulation of ATP increase is very sensitive to shear stress. As described in Tarran et al, Annu Rev Physiol., 68, 543-61 (2006), mechanical oscillating shear or compressive stress stimulates ATP release in epithelial cell cultures. In experiments conducted with cultured epithelial cells, a small increment in phasic shear of 0.01 dynes/cm² was shown to result in ˜100 fold increase in ATP levels. Further increase of phasic shear stress from 0.01 to 6 dynes/cm² caused an additional 6 fold increase in ATP levels. For comparison, normal breathing generates approximately 0.4-2 dynes/cm² shear stress in the airway walls (Tarran et al., J Biol Chem., 280(42), 35751-59, 2005) and 3 dynes/cm² in the nasal cavity (Elad, J Appl Physiol., 100, 1003-1010 (2006), whereas coughing can theoretically generate up to 1700 dynes/cm² (Basser et al., J Biomech Eng., 111(4), 288-97 (1989).

The increase in extracellular ATP also increases ion transport, which increases hydration of the airway surface liquid and the secretion of mucins. When normal and cystic fibrosis epithelial cell cultures are subjected to oscillating stress, the combined height of the periciliary liquid and mucus layers is significantly higher than that of the control cells not subjected to oscillating stress. Similarly, ciliary beat frequency is also significantly higher (Button et al., J Physiol., 580.2, 577-592 (2007)). As such, when ciliated epithelium in the respiratory tract is subjected to mechanically oscillating shear stress, the cells respond by stimulating secretion, increasing hydration, and increasing ciliary beat frequency. These increases in cilia beat frequency, hydration, and secretion of mucins collectively enhance the ability of the MCC system to propel the viscoelastic mucus containing trapped contaminants towards the pharynx to be swallowed into the gastrointestinal tract or expelled through the mouth.

Impairment of MCC mechanisms are understood to underlie a number of diseases and conditions of the upper and lower respiratory systems, Eustachian tube, and middle ear. Impairment of the MCC system usually begins with inflammation which triggers excess mucus secretion. This leads to dehydration of the airway surface liquid, which then causes cilia to collapse, which results in mucus accumulation and eventually infection. If MCC is not restored, it results in a vicious cycle of recurrent and worsening episodes of inflammation, mucus accumulation and infection, which can result in permanent cellular damage. Impaired MCC is found in devastating respiratory diseases such as chronic obstructive pulmonary disease (including chronic bronchitis and emphysema), asthma, cystic fibrosis and primary cilia dyskinesia. It is also found in upper respiratory conditions such as chronic sinusitis, allergic and non-allergic rhinitis, Eustachian tube dysfunction, and otitis media where quality of life is significantly impacted. While there are apparatuses and methods for treating these diseases and conditions, they often come with drawbacks and rather than directly restoring MCC, most current treatments only treat the symptoms.

Rhinitis and sinusitis are inflammation of the nasal and sinus mucosa membranes, which causes individuals to breathe through the mouth. When air flows through the nose, a significant portion of inhaled contaminants is removed in the nose and sinuses. Mouth breathing by-passes this filtering mechanism, resulting in more contaminants reaching the lower respiratory tract. There are two types of rhinitis: allergic rhinitis and non-allergic rhinitis. Allergic rhinitis occurs when the body overreacts to allergens such as pollen, molds, dust mites and animal dander with the production of antibodies; primarily, immunoglobin E (IgE). When IgE interacts with mast cells, several chemicals including histamine are released. Histamine causes the typical symptoms of rhinitis—sneezing, itchy/watery eyes, runny/itchy/congested nose. Non-allergic rhinitis does not involve the immune system and IgE is not present. Symptoms are similar to allergic rhinitis but the cause is unknown. Irritants in the air, certain odors, weather changes and certain foods are some of the triggers of non-allergic rhinitis. The cause of inflammation in sinusitis is not completely understood.

Saline rinses and medications such as anti-histamines and decongestants help manage the symptoms of rhinitis and sinusitis. These medications are not effective in completely alleviating all symptoms especially when the levels of triggers are high. Prolonged use of some nasal decongestant sprays exacerbates rhinitis and results in dehydration of the nasal passages. Avoidance of triggers is often recommended for individuals with these conditions, which usually means limiting activities outdoors or in areas where triggers are found. Depressed MCC is found in the nasal passages of individuals with rhinosinusitis. If MCC can be increased in these individuals, it is possible to use the body's innate system to prevent allergens and offending contaminants from reaching the epithelial cells of the nasal and sinus passages.

Chronic respiratory diseases such as asthma and chronic obstructive pulmonary disease (COPD), which includes chronic bronchitis and/or emphysema, kill over four million people worldwide annually and affect hundreds of millions more. Smoking is known to be a major cause of COPD. Chronic bronchitis is a chronic condition where the lining of the airways of the lungs (bronchii) is constantly irritated and inflamed. Inflammation in the lining causes excess mucus secretion and results in a persistent cough. Chronic bronchitis is a long-term respiratory illness and is clinically defined as a persistent cough that produces sputum and mucus for at least three months per year in two consecutive years. People with these devastating lower respiratory diseases and orphan diseases such as cystic fibrosis and primary cilia dyskinesia have depressed mucociliary clearance due to chronic inflammation and often struggle to breathe because of mucus accumulation and recurrent infections in the airways. Anti-inflammatories, bronchiodilators, mucolytics and antibiotics form a regiment of therapeutics prescribed for individuals with these devastating diseases to help keep their airways clear. These therapeutics are useful in treating symptoms of the diseases, but are not completely effective in restoring mucociliary clearance. Progression of diseases like COPD and cystic fibrosis are characterized by progressive damage to the lungs leading to shortness of breath and increased coughing.

In addition to medication, airway clearance devices such as high-frequency chest wall oscillation (HFCWO) vests and positive expiratory pressure (PEP) devices, such as Flutter® and Acapella® valves, are sometimes used as part of daily airway clearance routines in individuals with cystic fibrosis or COPD. HFCWO vests utilize rapid bursts of air to deliver pulsating compressions to the chest at high frequencies. PEP devices are devices into which a patient blows to create a back pressure that causes vibrations in the airways. HFCWO vests and PEP devices operate at frequencies of between 8-30 Hz. The operating frequencies of these types of devices are intended to create shear stress in the lower airways to loosen any mucus adhering to the epithelium; coughing is then used to move the loosened mucus to pharynx, where it can be expelled as sputum or removed by suction. Some of these high frequency devices cannot be tolerated by young children or individuals weakened by the diseases.

Cystic fibrosis (CF) and primary cilia dyskinesia (PCD) are genetic diseases that result in impairment of mucociliary clearance in both the upper and lower respiratory tract as well as the middle ear and Eustachian tube. The genetic mutation in CF results in abnormal chloride ion transport in epithelial cells. This causes dehydration of the periciliary and mucus layers in the epithelium of the respiratory tract leading to a reduction in the height of the periciliary fluid layer and build-up of thick mucus in the lungs. Cilia function is also impacted, resulting in poor MCC which leads to chronic inflammation and recurring infections. People with cystic fibrosis also have chronic rhinitis due to mucus accumulation in the nasal and sinus cavities. PCD is a genetic disorder of the ultrastructure and function of the cilia. People with PCD lack a functioning MCC system, have persistent infections in the lungs, ears and sinuses, and sustain permanent damage to their lungs, ears and sinuses over a period of time without aggressive treatment.

Other examples of disease states and/or conditions associated with impaired MCC are those involving the sinuses and the Eustachian tube. The sinuses are connected hollow cavities located in the cheekbones, forehead, between the eyes and behind the nasal cavity. When functioning normally, MCC keeps the sinuses clear of mucus. Sinusitis is inflammation of the sinuses, which can be due to infection, rhinitis, PCD, cystic fibrosis or a deviated septum. When the sinuses are inflamed, MCC is impaired and channels for mucus drainage are blocked causing mucus to accumulate in the sinus cavities. The trapped mucus provides a rich environment for bacterial growth, resulting in infections of the sinuses. Symptoms of sinusitis include headaches, facial pain, fever, fatigue and a decreased sense of smell. Sinusitis can be acute, lasting for less than four weeks, or chronic, when lasting longer than four weeks. About 30 million people in the US are diagnosed with sinusitis. Treatment for sinusitis includes use of antibiotics for infections, saline nasal rinses and use of medications such as corticosteroids, mucolytics and decongestants. Sinusitis and rhinitis often leads to inflammation in the Eustachian tube, resulting in Eustachian tube dysfunction (ETD).

The Eustachian tube provides the only access available to the outside atmosphere for the middle ear. If a subject suffers from ETD, the middle ear cannot adequately equilibrate its air pressure with that of the outside atmosphere. In ETD, inflammation in the Eustachian tube causes a failure for it to open adequately, which can result in negative pressure, mucus retention and infection in the middle ear. ETD is a condition that can cause a subject mild discomfort to extreme pain depending on the severity of the condition. If left untreated, prolonged ETD can lead to the accumulation of fluid and mucus in the middle ear, which provides a medium for incubating bacterial infections. Otitis media, which is an infection in the middle ear, can result. This may lead to tissue damage and hearing loss or impairment. There are 6 million people with otitis media in the US.

The Eustachian tube, also known as the pharyngotympanic tube, connects the middle ear and the nasopharynx. The Eustachian tube has three primary functions: it provides the middle ear access to the external atmosphere, thereby allowing the middle ear to equalize its air pressure with the atmospheric air pressure; it provides drainage of fluids that accumulate in the middle ear; and it protects the middle ear from sound waves and contaminants.

The Eustachian tube is normally closed, which prevents fluids and secretions in the nasopharynx from contaminating the middle ear. When functioning properly, the Eustachian tube opens through muscular action such as yawning, swallowing, sneezing or chewing. This intermittent opening of the Eustachian tube allows air to enter the middle ear from the nasopharynx, which equalizes the pressure in the middle ear with the atmospheric pressure. The opening of the Eustachian tube also allows fluids and mucus to drain from the middle ear. If these materials are not regularly drained, they accumulate in the middle ear, and they can lead to ear infections. Mucociliary clearance helps the drainage by pushing fluids and mucus in the middle ear towards the Eustachian tube.

Inflammation from an infection or an immune response, such as an allergic reaction or physical blockages (e.g., enlarged adenoids or tumors), can cause the frequency and duration of opening of the Eustachian tube to be insufficient for ventilation and drainage of the middle ear. Similarly, a buildup of excessive amounts of mucus can occlude the Eustachian tube and prevent it from functioning normally. In addition, mucus build-up and inflammation in the middle ear can decrease mucociliary clearance activity. This functional blockage of the Eustachian tube in ETD results in negative pressure in the middle ear relative to atmospheric pressure.

A subject with ETD may experience hearing impairment because the difference in pressure between the middle ear and the atmospheric pressure hampers the ability of the ear drum to vibrate freely in response to sound waves. A subject with ETD may experience fullness or pain in the ear, tinnitus, dizziness and loss of hearing. A subject with ETD may experience the sensation of popping in the ear. As ETD becomes more severe, frequency and duration of opening of the Eustachian tube are reduced to a point where the Eustachian tube is unable to open even when there is a significant change in atmospheric pressure. At this point, a subject may find it painful to travel by air because the middle ear pressure is unable to equilibrate during ascent and descent. If the pressure differential is significant enough, the ear drums may rupture.

Various manual methods may be used to try to clear blocked Eustachian tubes. A simple technique is to flex the muscles surrounding the Eustachian tube, e.g., by swallowing, yawning or chewing. Alternatively, the manual Valsalva maneuver, which involves pinching one's nose shut while taking a deep breath and blowing out while the mouth is closed, may be used to open the Eustachian tube briefly. However, the effectiveness of these methods often depends on the severity of the condition and may be dependent on anatomical differences between individuals. Young children who are often subject to a blocked Eustachian tube generally have difficulty performing some of these actions.

Devices have been described in an attempt to address the clearing of a blocked Eustachian tube for instances where manual techniques are ineffective. For example, U.S. Pat. No. 5,885,242 discloses an apparatus for equalizing pressure in a middle ear that includes a hand held air source for providing a continuous flow of air at a predetermined rate and a tapered sealing nostril plug. The tapered sealing nostril plug has a channel through which a continuous flow of air is delivered. A subject seals one nostril with the tapered sealed nostril plug, manually seals the other nostril, activates the device, and swallows. The combination of swallowing with the continuous flow of air, in theory, equalizes the pressure in the middle ear. However, channeling pressured airflow through the nasopharynx risks infection by blowing fluids and mucus from the nasal and oral cavities laden with bacteria into the middle ear.

Devices and methods for delivering vibrations have also been described in an attempt to address the clearing of a blocked Eustachian tube. For example, U.S. Patent Publication No. 2003/0172939 discloses an apparatus and method for relieving discomfort caused by congestion within a body cavity adjacent to at least one region of hard tissue by employing a vibration generator which generates mechanical vibrations at a subsonic frequency. The vibration generator is brought into non-invasive mechanical engagement with the hard tissue to transmit vibrations through the hard tissue to at least part of the body cavity. However the effectiveness of this device and method is dependent on the severity of the congestion, and on the ability of the user to locate and vibrate a suitable region of hard tissue. As such, the effectiveness of this device and method is varied.

While these methods can temporarily alleviate the discomfort associated with ETD by equilibrating the middle ear pressure to atmospheric pressure temporarily, they are not very effective in draining retained secretions from the middle ear. Therapeutic anti-inflammatory or anti-histamine agents are often prescribed in an attempt to treat otitis media or prevent blockage or inflammation of the Eustachian tube. However, these agents are usually not effective and some can have undesirable side effects such as drowsiness or fatigue as well as dehydration of the epithelium.

When the above methods fail to sufficiently ventilate the middle ear, recurring ear infections or otitis media may result. In this case, a surgery called myringotomy may be performed. Myringotomy is one of the most commonly performed out-patient surgeries in the United States. It consists of making an incision in the eardrum and inserting a pressure equalization tube to help ventilate the middle ear through the ear drum. Once inserted, care must be taken when swimming or bathing to ensure that water does not enter the tube and contaminate the middle ear. These equalization tubes eventually will fall out or have to be removed in 6-12 months. If a subject suffers from recurring ear infections due to continued Eustachian tube blockage, the surgery will have to be repeated. Repeated incisions in the eardrums can sometimes result in scarring. Additionally, the hole in the ear drum may not heal after the tubes are removed, requiring additional surgery to repair the hole.

While the upper respiratory conditions are not life threatening, chronic sinusitis, rhinitis, ETD and otitis media significantly impact the quality of life. In addition, upper infection in the nasal and sinus cavities can lead to infection in the lungs. Similarly, for asthma, if MCC is impaired in the upper respiratory tract, more inhaled particles will travel to the lower respiratory tract and become triggers for inflammation and cause constriction in the lungs. Devices such as HFCWO vests and PEP devices are designed to work on clearing mucus only in the lower respiratory system. There are no effective devices for directly improving MCC in the upper respiratory system or devices that target both the upper and lower respiratory systems simultaneously.

Therapeutic agents and medications, including anti-inflammatory agents, mucolytics, bronchiodilators, antibiotics, etc., are commonly prescribed and/or available over-the-counter for the treatment of respiratory diseases and related conditions such as Eustachian tube dysfunction and otitis media. However, these therapeutic agents and medications are designed to treat only the symptoms. None of them directly restores MCC and, as such, are not completely effective in preventing the progression of severe respiratory diseases. There are limited device options for airway clearance and existing devices targeting the lower respiratory system are limited to usage by a small patient population.

As such, the present invention provides methods and apparatuses to increase MCC in a subject to address the problem of ETD, as well as to treat various conditions and diseases of the upper and lower respiratory tracts, without the drawbacks and undesirable side-effects discussed above.

Receptor agonists that stimulate ion transport in conjunctival tissue in the eye are similar to those found in the respiratory epithelium. It was shown that increased ATP levels in conjunctival tissue also stimulates ion transport which results in increased tear secretion (see, Murakami et al., Current Eye Res., 21(4), 782-7 (2000)). Therefore, the present methods and apparatuses can be used to stimulate ATP secretion in the conjunctiva to treat dry eye syndrome (i.e., keratoconjunctivis sicca).

### V. Apparatuses

The methods of the present invention can be performed with an apparatus as described herein or with any apparatus or device capable of providing an oscillating lateral motion to the subject positioned in a supine position on a flat surface at a frequency of about 60 to about 200 cycles per minute and for a time period of about 2 to about 60 minutes.

In certain aspects, the present invention provides an apparatus (or device) for increasing mucociliary clearance (MCC) of a subject comprising:
a support for receiving a part of each leg (or other body part such as the torso) of the subject;
a vertical height adjustment mechanism for adjusting a height of the support along a vertical axis from the ground, the height having a measurement of about 100 mm to about 500 mm; and
a motion generator engaged with the support and configured to reciprocatingly move the support laterally in a reciprocating motion with a lateral displacement of about 20 mm to about 100 mm and at a frequency of about 60 to about 200 cycles per minute.

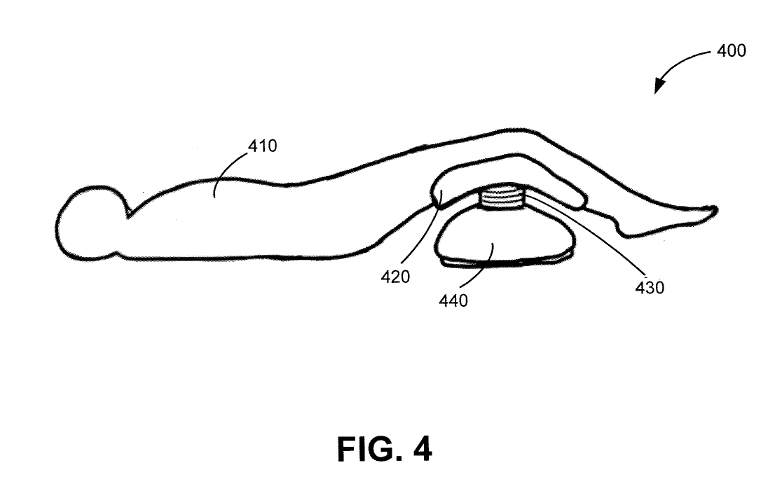

FIG. 4 illustrates an exemplary apparatus (400) wherein the subject (410) lies in a supine position on the apparatus comprising a support (420) for receiving a part of each leg of the subject, a vertical height adjustment mechanism (430) for adjusting a height of the support along a vertical axis from the ground, and a motion generator, optionally enclosed in a case, engaged with the support (440).

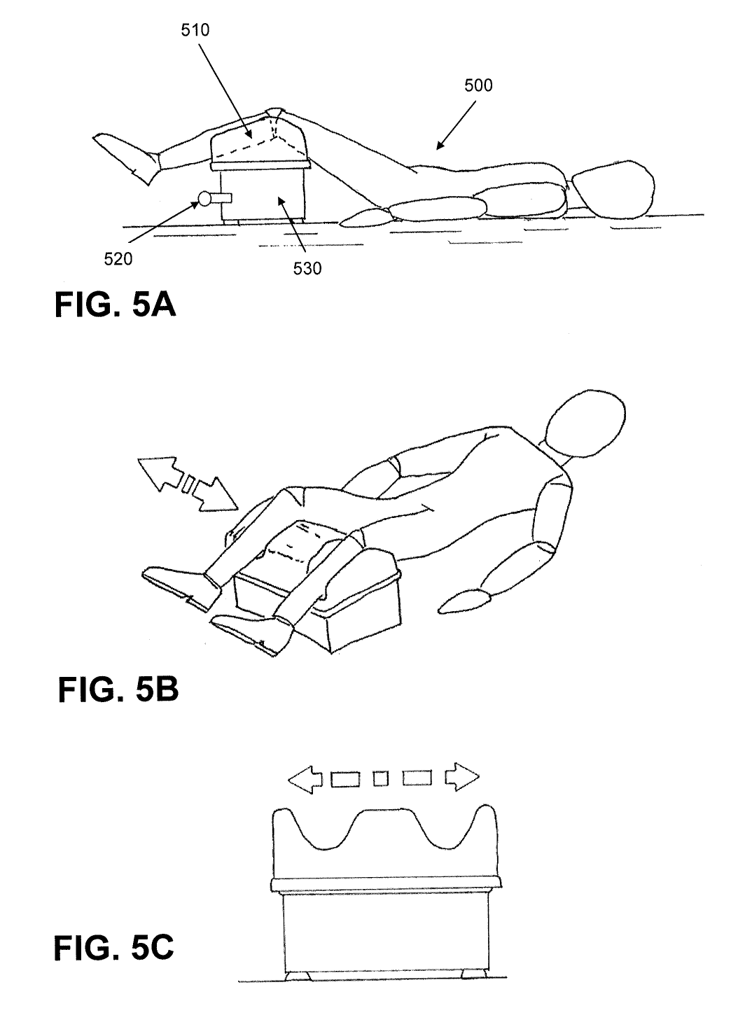

FIGS. 5A-C illustrate other embodiments of an exemplary apparatus of the invention. FIG. 5A illustrates a side view of the exemplary apparatus, wherein the subject (500) lies in a supine position on the apparatus comprising a support (510) for receiving a part of each leg of the subject, a vertical height adjustment mechanism (520) for adjusting a height of the support along a vertical axis from the ground (i.e., “height control”), and a motion generator, optionally enclosed in a case, engaged with the support (530). FIG. 5B illustrates a three-dimensional view of the exemplary apparatus, wherein the arrows indicate the direction of the oscillating lateral motion. FIG. 5C illustrates a view of the exemplary apparatus showing a saddle-type structure for support holding a part of each leg of the subject, wherein the arrows indicate the direction of the oscillating lateral motion.

In particular embodiments, the reciprocating motion comprises an oscillating lateral motion that is applied at a frequency of about 60 to about 200 cycles per minute (CPM), e.g., about 90 to about 180 CPM, about 110 to about 160 CPM, about 120 to about 160 CPM, about 130 to about 150 CPM, or about 60, 70, 80, 90, 100, 110, 120, 130, 135, 140, 145, 150, 160, 170, 180, 190, or 200 CPM. In other embodiments, the lateral displacement is about 20 mm to about 80 mm, about 20 mm to about 50 mm, about 25 mm to about 75 mm, about 30 mm to about 70 mm, about 50 mm to about 100 mm, or about 20, 30, 40, 50, 60, 70, 80, 90, or 100 mm.

In other embodiments, the height of the support along the vertical axis from the ground has a measurement of about 150 mm to about 450 mm, about 200 mm to about 500 mm, about 200 mm to about 400 mm, about 100 mm to about 300 mm, about 300 mm to about 500 mm, or about 100, 150, 200, 250, 300, 350, 400, 450, or 500 mm.

In some embodiments, the motion generator comprises:
a motor;
a reduction gear connected to the motor;
a crank arm connected to the reduction gear;
a sliding member connect to the crank arm; and
a support connected to the sliding member.

In other embodiments, the apparatus further comprises a tilt adjustment mechanism for adjusting an angle of the support relative to a horizontal plane.

In particular embodiments, the apparatus increases MCC in the Eustachian tube, middle ear, and/or respiratory tract (e.g., upper and/or lower respiratory tract) of a subject.

In certain embodiments, the part of each leg of the subject is selected from a hip, an upper leg, a thigh, a knee, a lower leg, a calf, an ankle, a foot, and combinations thereof. In certain other embodiments, the reciprocating motion comprises one or more waveforms selected from triangular, sawtooth, square, sine, and any combination thereof.

In some embodiments, the apparatus further comprises:
a remote control module configured to perform one or more functions selected from the group consisting of turning the apparatus on, turning the apparatus off, adjusting a frequency of the reciprocating motion, adjusting the lateral displacement of the reciprocating motion, adjusting a waveform of the reciprocating motion, adjusting a duration of the reciprocating motion, adjusting the vertical height of the support, adjusting an angle of the support relative to a horizontal plane, and any combination thereof.

In other embodiments, the apparatus further comprises:
a microprocessor configured to perform one or more functions selected from the group consisting of turning the apparatus on, turning the apparatus off, adjusting a frequency of the reciprocating motion, adjusting the lateral displacement of the reciprocating motion, adjusting a waveform of the reciprocating motion, adjusting a duration of the reciprocating motion, adjusting the vertical height of the support, adjusting an angle of the support relative to a horizontal plane, receiving physical and physiological information associated with the subject, storing physical and physiological information associated with the subject, retrieving physical and physiological information associated with the subject, and any combination thereof.

In yet other embodiments, the apparatus further comprises a microprocessor configured to adjust one or more operational variables of the apparatus based at least in part on one or more physical and physiological parameters associated with the subject.

In certain instances, the one or more operational variables of the apparatus is selected from the group consisting of a frequency of the reciprocating motion, the lateral displacement of the reciprocating motion, a waveform of the reciprocating motion, a duration of the reciprocating motion, the vertical height of the support, an angle of the support relative to a horizontal plane, and any combination thereof.

In certain other instances, the one or more physiological parameters associated with the subject is selected from the group consisting of a respiratory rate of the subject, a heart rate of the subject, blood oxygen level of the subject, and any combination thereof.

In further instances, the microprocessor stores and retrieves information selected from the group consisting of a frequency of the reciprocating motion, the lateral displacement of the reciprocating motion, a waveform of the reciprocating motion, a duration of the reciprocating motion, the vertical height of the support, an angle of the support relative to a horizontal plane, a respiratory rate of the subject, a heart rate of the subject, blood oxygen level of the subject, and any combination thereof.

In one particular exemplary embodiment, the present invention provides an apparatus for increasing MCC in the Eustachian tube, middle ear, sinus and nasal cavities, trachea, bronchi and bronchioles of a subject, the apparatus comprising: a support for receiving a part of each leg of the subject, the support having a vertical height adjustment mechanism and a tilt adjustment mechanism; a motion generator having a motor, a reduction gear connected to the motor, and a crank arm connected to the reduction gear and having the support connected to the crank arm that moves the support laterally in a reciprocating motion; a casing in which the motion generator is mounted; and the support being positioned at a height of about 100 to about 500 mm above the base of the casing and reciprocating with a lateral displacement of about 20 mm to about 100 mm and at a frequency of about 60 to about 200 cycles per minute.

The present invention also provides a non-invasive apparatus for treating ETD; primary ciliary dyskinesia (PCD); cystic fibrosis; conditions of the upper respiratory tract such as allergic rhinitis, non-allergic rhinitis, sinusitis; and diseases of the lower respiratory tract such as chronic bronchitis, emphysema and asthma. In one embodiment, a subject in need of treatment for one or more of the above can employ the method by laying supine on a flat surface (e.g., a floor, a mattress, a pad, a table top, etc.) and utilizing an apparatus capable of inducing oscillating shear stress in the subject's upper and lower respiratory tracts, middle ear, and Eustachian tube. The apparatus is positioned under a part of the subject's leg (e.g., the ankle, thigh, calf or back of the knee) and delivers an oscillating lateral motion to the part of each leg that is transmitted to the upper body.

In certain embodiments, the lateral motion to the part of each leg of the subject is for a period of about 2 to about 60 minutes, e.g., about 10 to about 50 minutes, about 20 to about 45 minutes, about 25 to about 35 minutes, or about 2, 5, 10, 20, 30, 40, 50, or 60 minutes.

In other embodiments, the lateral motion to the part of each leg of the subject provides a side to side twisting motion to the hips, torso, and/or head of the subject at a frequency of about 60 to about 200 cycles per minute. In some embodiments, the part of the leg comprises the hip, upper leg, thigh, knee, lower leg, calf, ankle, and/or foot.

In certain embodiments, the apparatus provides oscillating lateral motion to a subject comprising, e.g., a support for receiving a part of the subject's leg, vertical and tilt adjustment mechanisms configured to raise, lower and tilt the support to a comfortable and effective height and angle, and a motion generator configured to reciprocatingly move the support laterally in a reciprocating motion.

In certain embodiments, the apparatus provides an oscillating lateral motion to a part of each leg of a subject positioned in a supine position on a flat surface. The lateral motion results in movement in the body of the subject in the form of a sinusoidal wave that travels from the part of the leg that is in contact with the apparatus to the head of the subject. When the sinusoidal wave arrives at the hips of the subject, the wave imparts a side to side twisting motion to the body of the subject because the weight of the subject centered at the hips, along the spine and at the back of the head prevents lateral movement of the body. The side-to-side twisting motion continues from the hips to the thorax to the head of the subject. This side-to-side twisting motion of the thorax, when sustained for a period of time and at a frequency suitable for the subject, creates oscillating shear stress along the lining of the trachea, bronchi and bronchioles, which increases MCC in the lower respiratory tract. The side-to-side twisting motion at the head of the subject, when sustained for a period of time and at a frequency suitable for the subject, also creates oscillating shear stress along the lining of the middle ears, Eustachian tubes, sinuses and nasal cavities, which increases MCC in the upper respiratory tract. In one aspect of the present invention, the oscillating lateral motion generates shear stress in a range of about 0.01 to about 10 dynes per cm², e.g., about 0.1 to about 5 dynes per cm² or about 0.2 to about 2 dynes per cm².

The frequency and amplitude of the side-to-side twisting motion is regulated by the frequency and amplitude of the lateral displacement imparted to the part of the leg of the subject from the support of the apparatus. In some embodiments, the oscillating lateral motion translates into a lateral displacement of about 5 mm to about 20 mm (e.g., about 8 mm to about 14 mm) of the forehead of the subject. In other embodiments, the oscillating lateral motion translates into a longitudinal displacement of about 0.5 mm to about 5 mm (e.g., about 1 mm to about 2 mm) of the forehead of the subject.

The side-to-side twisting motion imparted to the head of the subject should be sufficient to bring about the desired result of clearing the Eustachian tube, middle ear, sinus cavities and nasal cavity, but not so vigorous as to cause discomfort or injury to the subject. The waveform of the oscillating lateral motion generated by the motion generator may be triangular, sawtooth, square, sine, or any combination thereof.

In some embodiments, the apparatus includes a motion generator comprising an assembly that includes a motor, a reduction gear, a crank arm and a sliding member. The motor is connected to the reduction gear and the reduction gear is connected to the crank arm, which is connected to the sliding member. When the sliding member is engaged with the support, the motion generator creates an oscillating lateral motion to the support.

In other embodiments, the apparatus includes a vertical height adjustment mechanism that allows the vertical height of the support of the apparatus to be raised or lowered. The vertical height adjustment mechanism may be a manually operated mechanical device such as, for example, a knob or crank that is accessible from the outside of the support of the apparatus, which a subject can turn. The knob or crank may be affixed to a gear screw that is engaged to at least one additional set of gears, which translates the rotational motion of the gear screw to an engaged screw oriented in the vertical direction whose engagement results in an increase or a decrease in the vertical height of the support. Alternatively, the vertical height adjustment mechanism may be an electrically operated device such as, for example, a servo or motor capable of being operated by the subject. In yet another embodiment, the height mechanism may be provided by a set of air bladders lining the support that when inflated, firmly grip a part of the leg and also provide the necessary height adjustment. In yet another embodiment, the height mechanism may be adjusted by removable attachments configured to deliver different heights.

In some embodiments, the apparatus leg tranduction module includes a tilt adjustment mechanism that allows the angle of the support of the apparatus to be adjusted in the longitudinal direction. As with the vertical height adjustment mechanism, the tilt adjustment mechanism may be operated manually or electrically. In certain embodiments, a knob or crank is affixed to a gear screw that is engaged to at least one additional set of gears. These gears translate rotational motion of the gear screw to an engaged screw oriented in the horizontal direction whose engagement results in an increase or a decrease in the tilt of the support relative to a horizontal plane in the longitudinal direction. By turning the knob or crank, a subject can adjust the tilt of the support. In alternative embodiments, the tilt adjustment mechanism may be an electrically operated device such as, for example, a servo or motor capable of being operated by the subject. In yet another embodiment, the tilt mechanism may be provided by a set of air bladders that when inflated, firmly grip a part of the leg and also provide the necessary tilt adjustment. In yet another embodiment, the tilt mechanism may be adjusted by removable attachments configured with different tilt angles.

In other embodiments, the apparatus includes an optional remote control unit that electrically turns the machine on or off and adjusts the frequency and lateral displacement of the reciprocating motion. The remote control unit in this embodiment may also adjust the waveform of the reciprocating motion. In another embodiment, the apparatus includes a remote control unit that electrically adjusts the duration of a treatment session, the vertical height of the support, and the tilt angle of the support.

In further embodiments, the apparatus includes a microprocessor that monitors various physical and physiological parameters of a subject and adjusts various apparatus operational variables, such as frequency, waveform, lateral displacement, and duration of the reciprocating motion depending on the monitored parameters of the subject. The apparatus may be equipped with sensors to monitor a subject's respiratory rate, blood oxygen level and pulse, as well as the frequency, lateral displacement, duration, progress of a session and any combinations thereof. Signals from these sensors may be fed back into a microprocessor which adjusts the frequency, waveform and duration of the reciprocating motion of the apparatus to optimize treatment effectiveness and comfort for the subject. In yet another embodiment, the microprocessor stores and accesses stored records of various subjects so as to automatically adjust and configure an apparatus for a given subject, such as the vertical height of the support, the tilt angle of the support, and the duration, frequency, waveform and lateral displacement of the reciprocating motion.

In particular aspects, the apparatuses and devices used in the methods of the invention are commercially available therapeutic massagers or aerobic exercisers capable of generating an oscillating motion at frequencies of about 60-200 CPM (e.g., about 90-150 CPM). These types of apparatuses and devices typically consist of a raised cradle for the ankles and are used by a subject while lying down. The cradle oscillates from side-to-side, generating a sinusoidal wave that travels from the ankle to the head to provide mild shear stress in the respiratory tract. Non-limiting examples of therapeutic massagers and aerobic exercisers include the ‘Chi Machine’ marketed by HsinTen, the ‘Chi Vitalizer’ marketed by US Jaclean, the device described in U.S. Pat. No. 5,107,822, and the like.

### VI. Examples

The following examples further illustrate the invention but are not to be construed as in any way limiting its scope.

### Example 1

Previous in vitro studies have demonstrated that oscillatory mechanical shear stress on the airway epithelium induced by normal breathing significantly increases luminal ATP release, airway surface height and cilia beat frequency. Normal breathing has a frequency of about 28 cycles per minute (CPM), 14 breaths in and 14 breaths out. There are several existing devices that use the principle of oscillating shear stress at frequencies significantly higher than breathing, i.e., 8-30 Hz or 480-1800 CPM to facilitate mucus clearance. The present study was conducted in accordance with the methods of the invention where of oscillating shear stress at frequencies of 70 and 140 CPM were applied to human airway cultures. This study evaluated the effect on ATP, airway surface liquid height, and cilia beat frequency compared to 28 CPM (i.e., breathing rate). ATP concentration, airway surface liquid height, and cilia beat frequencies were all found to be significantly higher when cells were subjected to shear stress at frequencies of 70 and 140 CPM compared to a frequency of 28 CPM. Since increases in these three factors are key to increasing mucociliary clearance, this study demonstrates that the methods of the invention are particularly useful for providing mechanically generated oscillations at frequencies of about 60 to about 200 CPM (e.g., 70-140 CPM) to improve mucociliary clearance.

Control of the volume of the liquid that line the respiratory tract is vital for pulmonary defense. Normal airway epithelia “autoregulate” the airway surface liquid (ASL) to a height that is efficient for mucus transport. Recent studies demonstrate that regulation of the ASL at a physiologically appropriate height in normal airways is associated with balancing of opposing ion transport systems, namely Na+ absorption and Cl− secretion. However, in diseases such as cystic fibrosis (CF) and COPD, increases in mucus production and concentration result in a decreased mucus clearance and persistent bacterial infection in the airways. Key signaling molecules that coordinate the net rate of ion transport, i.e., salt absorption or secretion, are the purine nucleotides and nucleosides, such as adenosine triphosphate (ATP), that are contained in the ASL. Airway cells constitutively release ATP into the lumen, which, with its metabolites, act in an autocrine/paracrine fashion to activate luminal P2- and P1-purinoceptors, regulating both Na+ and Cl− transport and hence stimulating ASL height and mucociliary clearance. Previous studies have shown that mechanical stimulation of airway cells by oscillatory mechanical stresses, mimicking breathing at 28 CPM, stimulates the release of ATP into the airway lumen, sufficient to restore ASL height to levels adequate for proper MCC and increase cilia beat frequency (CBF) (Tarran et al., J Biol Chem 280(42), 35751-59, 2005; Button et al., Resp Physiol Neurobiol. 163(1-3), 189-201, 2008).

This example demonstrates that the methods of the invention can be performed using devices that mechanically generate oscillations at about 60-200 CPM to improve mucociliary clearance for patients by increasing ATP release, thus increasing ASL height and CBF. In vitro studies were designed to assess the effect of oscillating shear stress at 28, 70 and 140 CPM on ATP release, airway surface hydration and CBF using a well-differentiated human airway culture model system. The frequencies of 70 and 140 CPM were chosen to mimic the oscillatory motion of airways in accordance with the methods of the present invention, while 28 CPM represents the oscillatory motion of normal breathing.

### Methods

Culturing of Human Airway Cell Cultures:

The studies utilized cultured primary human bronchial epithelial (HBE) cells. These cells, obtained from the University of North Carolina (UNC) CF Tissue Culture Core under the auspices of protocols approved by its Institutional Review Board (IRB), were from excess tissue from donor lungs and excised recipient lungs that were obtained at the time of lung transplantation. Cells from the excised bronchial specimens were isolated by a well-established protocol utilizing protease digestion. For these studies, passage-2 cells were seeded at 10⁶ cells/cm² on 12-mm permeable support (Transwell-Clear; Costar) pre-coated with human placental collagen. Cells were maintained under air-liquid conditions, washed every 48-72 h to remove accumulated mucus, and studied as fully differentiated cultures (3-4 week cultures with transepithelial resistances of >200 Ω·cm²). All incubations were performed in a well-humidified (>95%) tissue culture incubator (5% CO2) at 37° C.

Application of Oscillating Shear Stress:

A system described in Button et al., J. Physiol. 580(2), 577-592 (2007) was utilized to subject airway cultures to well-defined shear stresses. This system, which uses an oscillatory start-stop motion, was programmed to elicit the desired frequency, acceleration/deceleration rates, and maximum displacement. Well-differentiated airway cultures were subjected to shear stress of 0.2-0.6 dynes per cm² for 30 minutes prior to removal for subsequent analysis. Sham controlled cultures were placed in similar supports, but not subjected to shear stress.

Luminal ATP Measurements:

20 μl of saline was added to the luminal surface of the HBE cultures immediately before being subjected to oscillating shear stress. Immediately after the removal from the shear-stress apparatus, a 10 μl aliquot was carefully removed. 2-5 μl sample of the aliquot was added to a test tube and the volume adjusted to 300 μl with HPLC-grade water. 100 μl of the luciferin-luciferase reaction mix (300 μM luciferin, 5 μg/ml luciferase, 6.25 mM MgCl2, 0.63 mM EDTA, 75 mM dithiothreitol, 1 mg/ml bovine serum albumin, 25 mM HEPES, pH 7.8) was added to the sample. Luminescence was detected by a photomultiplier and integrated over 10 sec. The recorded arbitrary counts from each sample were counted in duplicate and compared against an ATP standard curve performed in parallel. Luminescence was linear between 0.1 to 1000 nM ATP.

Measurement of Airway Surface Hydration Dynamics:

Freshly washed cells were pre-stained by a 15-min exposure to 10 μM calcein-AM to visualize the airway epithelial cells. To visualize the airway surface liquid (ASL), isotonic saline containing 0.2% vol/vol Texas Red-dextran (70 kDa, Invitrogen) was briefly nebulized onto the lumen of cultures. This volume of saline only resulted in minor increase in the ASL height of ˜3 μm, for a total pre-study thickness of ˜10 μm. After 30 minutes of oscillatory stress (or sham control), sequential images of the cells and ASL layer were acquired every 30 seconds by laser-scanning confocal microscopy (Model SP5; Leica) using the appropriate filters (540 nm excitation/630 emission and 488 excitation/530 nm emission for Texas Red and calcein, respectively). Images were obtained every 30 minutes for up to 2 hours following removal from the shear-stress apparatus.

Cilia Beat Frequency (CBF) Measurements:

Freshly washed cultures were temperature equilibrated to 37° C. for 10 minutes on the stage of a microscope prior to the initiation of the experimental procedure. Images of cilia were recorded on an inverted phase contrast microscope (TE 2000; Nikon) using a 20× objective. High-speed (125 Hz) video images were captured with an 8-bit b/w camera (GS-310 Turbo, Megaplus). The analog signal was digitized via an analog-to-digital converter board (A/D; National Instruments.). A digital computerized CBF analysis system was used to analyze the acquired video images, using specialized software based on Sisson-Ammons Video Analysis (Ammons Engineering). CBF measurements were obtained in real-time to provide a time-course of CBF before and at various time-points up to 60 minutes following removal of the cultures from the shear-stress apparatus.

Statistical Analysis:

For all studies, the data obtained were evaluated with one-way ANOVA followed by paired wise multiple comparisons using Holm-Sidak method.

### Results

Effect on Airway Surface Hydration:

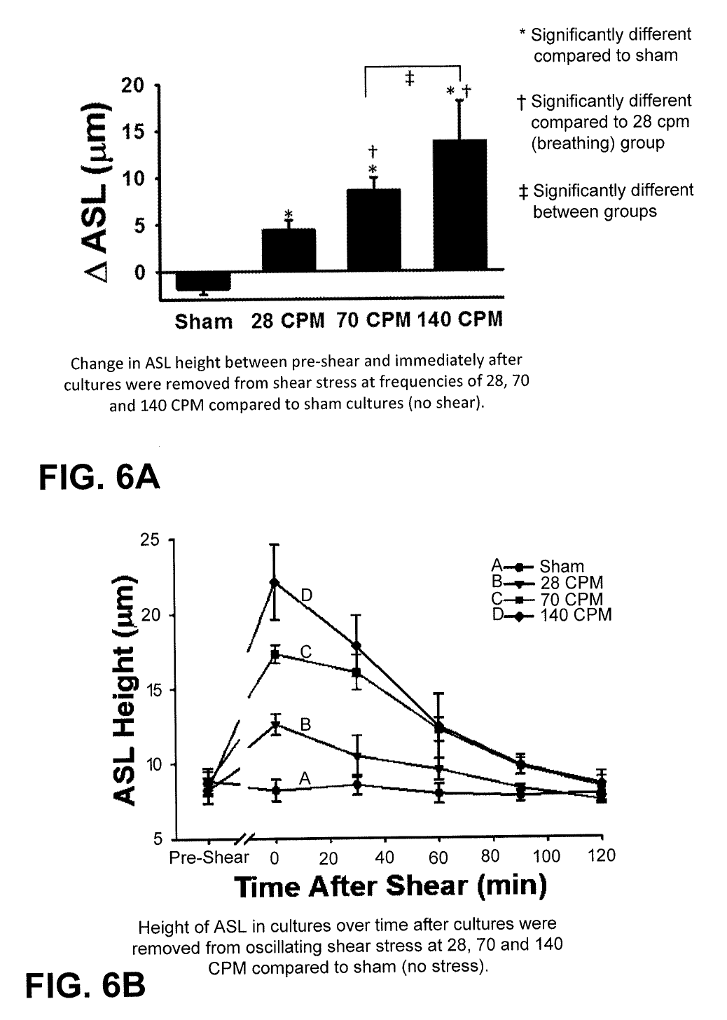

All groups receiving oscillating shear stress had a significant change in ASL height compared to sham. FIG. 6A shows the absolute difference in ASL height (Δ μm) between pre-shear and immediately following removal from the shear stress device. While a slight decrease in ASL height was observed in the sham (no stress) group, there was a significant increase in ASL height that was dependent on the frequency of the oscillating stress, with the 70 and 140 CPM groups being statistically different than breathing (i.e., 28 CPM) alone. The magnitude of change in ASL height was dependent on the frequency of shear stress (FIG. 6A). The increase in ASL height of the 140 CPM and 70 CPM groups were 3× and 2× higher, respectively, over that observed in the 28 CPM (normal breathing) group. After removal from the shear stress, ASL height slowly returned to baseline in 120 minutes due to re-absorption of the excess fluid (FIG. 6B).

Effect on ATP Concentration:

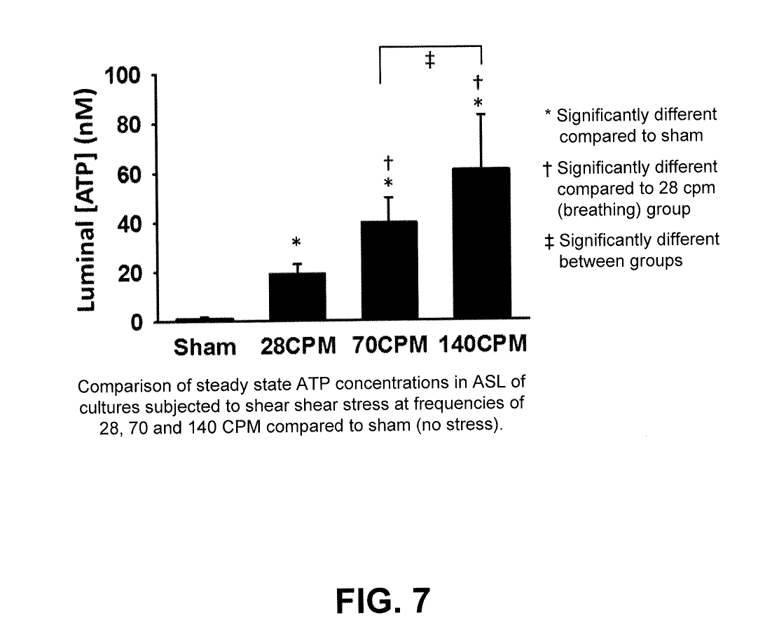

The release of ATP was dependent on the frequency of shear stress (FIG. 7). Shear stress applied at 140 CPM produced an increase in steady-state ATP concentration that was about 50% higher than at 70 CPM. ATP release in the 70 CPM group was 100% higher than the 28 CPM (normal breathing) group, which was statistically higher than the sham cultures.

Effect on Cilia Beat Frequency:

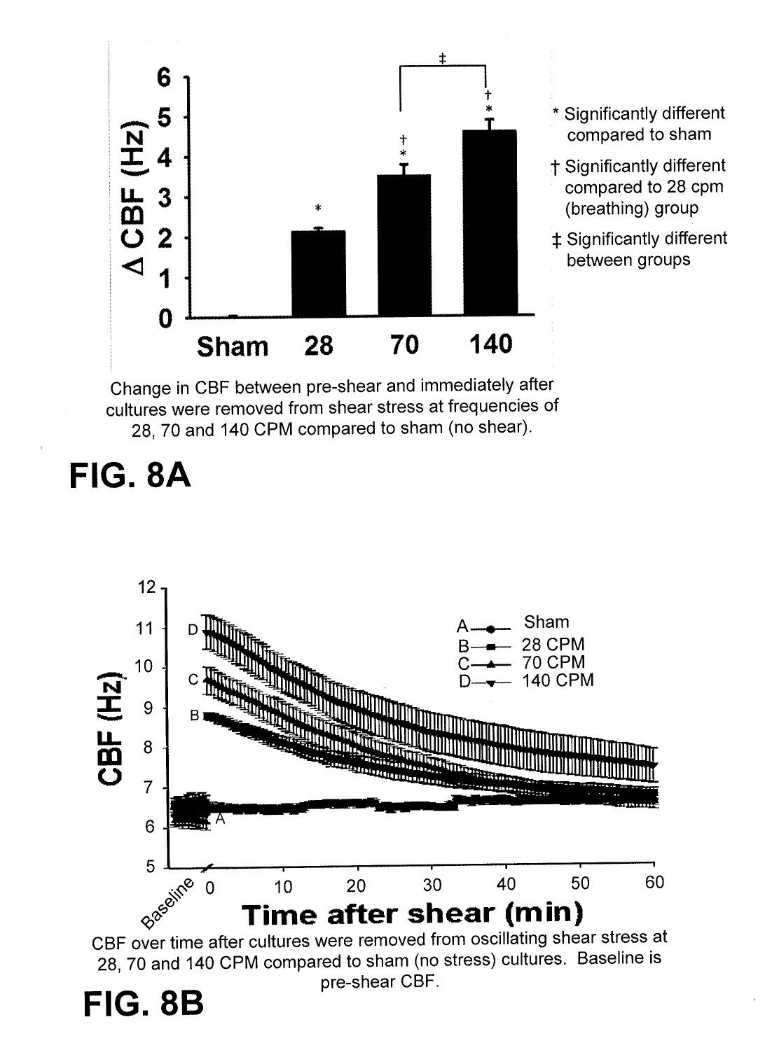

As shown in FIG. 8A, the oscillation shear stress at all three frequencies resulted in a significant increase in the CBF over pre-shear values compared to sham. The magnitude of change in CBF was the highest in the 140 CPM group and was about 2× compared to the change in the 28 CPM (normal breathing) group. The change in CBF in the 70 CPM group was 1.6× higher than the change in the 28 CPM group. As shown in FIG. 8B, the elevated CBF for the 28 and 70 CPM decreased to baseline by 60 minutes after removal of the shear stress. However, the CBF for 140 CPM group remained above baseline at 60 minutes.

In summary, this example demonstrates that subjecting airway epithelium to oscillating shear stress in the range of 70-140 CPM resulted in significant increases in ATP release, ASL height, and CBF compared to cells subjected to stress typical of normal breathing at 28 CPM. Since increases in ATP, ASL height, and CBF are key factors to enhancing mucus clearance, devices that are capable of generating oscillating shear stress in airway epithelium within this frequency range are useful in the methods of the present invention for preventing or treating conditions of the Eustachian tube or middle ear as well as upper and lower respiratory diseases where mucociliary clearance is impaired.

### Statistical Analysis

Statistical Analysis of ASL Data

One Way Analysis of Variance

Change in ASL height from baseline/pre-shear

| Group Name | N | Missing | Mean | Std Dev | SEM |
|---|---|---|---|---|---|
| Sham | 9 | 0 | −1.848 | 1.073 | 0.358 |
| 8-CPM | 3 | 0 | 4.370 | 1.081 | 0.624 |
| 70-CPM | 9 | 0 | 8.553 | 1.417 | 0.472 |
| 140-CPM | 9 | 0 | 13.836 | 4.327 | 1.442 |
| Source of Variation | DF | SS | MS | F | P |
| Between Groups | 3 | 1162.767 | 387.589 | 56.807 | <0.001 |
| Residual | 26 | 177.395 | 6.823 | | |
| Total | 29 | 1340.162 | | | |

Power of performed test with alpha = 0.050: 1.000
All Pairwise Multiple Comparison Procedures (Holm-Sidak method):
Overall significance level = 0.05

Comparisons for Factor:

| | Diff | | Unadjust- | Critical | Signif- |
|---|---|---|---|---|---|
| Comparison | of Means | t | ed P | Level | icant? |
| 140-CPM vs. | 15.684 | 12.737 | <0.001 | 0.009 | Yes |
| Sham | | | | | |
| 70-CPM vs. | 10.401 | 8.447 | <0.001 | 0.010 | Yes |
| Sham | | | | | |
| 140-CPM vs. | 9.466 | 5.436 | <0.001 | 0.013 | Yes |
| 28-CPM | | | | | |
| 140-CPM vs. | 5.283 | 4.290 | <0.001 | 0.017 | Yes |
| 70-CPM | | | | | |
| 28-CPM vs. | 6.218 | 3.571 | 0.001 | 0.025 | Yes |
| Sham | | | | | |
| 70-CPM vs. | 4.183 | 2.402 | 0.024 | 0.050 | Yes |
| 28-CPM | | | | | |

Statistical Analysis of ATP Data

One Way Analysis of Variance

| Group Name | N | Missing | Mean | Std Dev | SEM |
|---|---|---|---|---|---|
| Sham | 9 | 0 | 1.043 | 0.723 | 0.241 |
| 28-CPM | 9 | 0 | 18.950 | 4.076 | 1.359 |
| 70-CPM | 9 | 0 | 39.558 | 10.118 | 3.373 |
| 140-CPM | 9 | 0 | 60.758 | 22.210 | 7.403 |
| Source of Variation | DF | SS | MS | F | P |
| Between Groups | 3 | 17981.633 | 5993.878 | 39.125 | <0.001 |
| Residual | 32 | 4902.343 | 153.198 | | |
| Total | 35 | 22883.976 | | | |

Power of performed test with alpha = 0.050: 1.000
All Pairwise Multiple Comparison Procedures (Holm-Sidak method):
Overall significance level = 0.05

Comparisons for Factor:

| | Diff | | Unadjust- | Critical | Signif- |
|---|---|---|---|---|---|
| Comparison | of Means | t | ed P | Level | icant? |
| 140-CPM vs. | 59.714 | 10.234 | <0.001 | 0.009 | Yes |
| Sham | | | | | |
| 140-CPM vs. | 41.808 | 7.165 | <0.001 | 0.010 | Yes |
| 28-CPM | | | | | |
| 70-CPM vs. | 38.514 | 6.601 | <0.001 | 0.013 | Yes |
| Sham | | | | | |
| 140-CPM vs. | 21.200 | 3.633 | <0.001 | 0.017 | Yes |
| 70-CPM | | | | | |
| 70-CPM vs. | 20.608 | 3.532 | 0.001 | 0.025 | Yes |
| 28-CPM | | | | | |
| 28-CPM vs. | 17.907 | 3.069 | 0.004 | 0.050 | Yes |
| Sham | | | | | |

Statistical Analysis of Cilia Beat Frequency Data

One Way Analysis of Variance

Change in CBF from Baseline/Pre-Shear

| Group Name | N | Missing | Mean | Std Dev | SEM |
|---|---|---|---|---|---|
| Sham | 9 | 0 | 0.0111 | 0.0983 | 0.0328 |
| 28-CPM | 6 | 0 | 2.120 | 0.223 | 0.0908 |
| 70-CPM | 9 | 0 | 3.490 | 0.852 | 0.284 |
| 140-CPM | 9 | 0 | 4.588 | 0.885 | 0.295 |
| Source of Variation | DF | SS | MS | F | P |
| Between Groups | 3 | 104.390 | 34.797 | 81.478 | <0.001 |
| Residual | 29 | 12.385 | 0.427 | | |
| Total | 32 | 116.775 | | | |

Power of performed test with alpha = 0.050: 1.000
All Pairwise Multiple Comparison Procedures (Holm-Sidak method):
Overall significance level = 0.05

Comparisons for Factor:

| | Diff | | Unadjust- | Critical | Signif- |
|---|---|---|---|---|---|
| Comparison | of Means | t | ed P | Level | icant? |
| 140-CPM vs. | 4.577 | 14.856 | <0.001 | 0.009 | Yes |
| Sham | | | | | |
| 70-CPM vs. | 3.479 | 11.294 | <0.001 | 0.010 | Yes |
| Sham | | | | | |
| 140-CPM vs. | 2.467 | 7.164 | <0.001 | 0.013 | Yes |
| 28-CPM | | | | | |
| 28-CPM vs. | 2.109 | 6.124 | <0.001 | 0.017 | Yes |
| Sham | | | | | |
| 70-CPM vs. | 1.370 | 3.978 | <0.001 | 0.025 | Yes |
| 28-CPM | | | | | |
| 140-CPM vs. | 1.097 | 3.562 | 0.001 | 0.050 | Yes |
| 70-CPM | | | | | |

### Example 2

The mucociliary clearance system consists of three components: mucin secretion; an ion transport mechanism to maintain airway hydration; and synchronous cilia activity. In vitro studies have shown that oscillating shear stress on the airway epithelium stimulates the release of luminal adenosine triphosphate, which, via purinoceptors, induces increases in airway hydration and cilia beat frequency. Current mucus clearance devices utilize oscillating shear stress at very high frequencies of 8-30 Hz. This example demonstrates that using oscillating motion at much lower frequencies of about 1-3 Hz (e.g., 60-200 CPM) are effective in improving mucociliary clearance. This was demonstrated when an exemplary apparatus was used to apply external oscillating motion to induce oscillating shear stress in the upper respiratory tract of individuals with otitis media. The oscillating shear stress at much lower frequencies of about 60-200 CPM increased MCC sufficiently to cause the Eustachian tube to open intermittently and allowed equilibration of middle ear pressure.

Mucociliary clearance (MCC) is an innate defense mechanism that protects the lungs from inhaled pathogens and pollutants. The MCC mechanism consists of three components, mucin secretion by goblet cells, ion transport mechanism that maintains adequate hydration of the airway surface liquid (ASL), and cilia lining the airway surface that beat synchronously to move mucus towards the pharynx to be swallowed or coughed out. Epithelia, consisting of ciliated and goblet cells, lining the middle ear, Eustachian tube, nasal and sinus cavities, trachea, bronchi and bronchioles, form the MCC system. In diseases such as cystic fibrosis (CF), chronic obstructive pulmonary obstruction (COPD), chronic rhinitis and otitis media, MCC is impaired.

Previous studies have demonstrated that mechanical stimulation of airway cells by oscillatory mechanical stresses, mimicking breathing at 28 cycles per minute (CPM), increases MCC by stimulating the release of luminal adenosine triphosphate ATP (Tarran et al., J Biol Chem 280(42), 35751-59, 2005; Button et al., Resp Physiol Neurobiol. 163(1-3), 189-201, 2008). Luminal ATP increases induce increases in ASL height and cilia beat frequency (CBF), which results in enhanced mucus clearance. This study demonstrates that the methods of the invention can mechanically generate oscillating shear stresses in the upper and lower respiratory tract of subjects at frequencies slightly higher than normal breathing to improve mucus clearance better than normal breathing. Unlike existing devices such as High Frequency Chest Wall Oscillation vests and positive expiratory devices that operate at 8-30 Hz, the present invention provides methods and devices that operate at about 1-3 Hz, e.g., about 60-200 CPM. In addition, unlike existing methods and devices that are directed only at the lower respiratory system, the present invention provides methods and devices that are designed to work on both the upper and lower respiratory tract at the same time.

Subjects with otitis media have negative middle ear pressure that is due to a blocked or partially blocked Eustachian tube usually caused by inflammation. This study demonstrates that the methods of the invention increase MCC in the middle ear and Eustachian tube sufficiently to enable the Eustachian tube to open, thus allowing the middle ear pressure to equilibrate towards ambient pressure, resulting in a detectable increase in the middle ear pressure as determined by tympanometry. Middle ear pressure was measured pre- and post-treatment using an exemplary device such as a therapeutic massager in subjects with initial negative middle ear pressure and improvement of middle ear pressure was a reflection of improved MCC in the respiratory tract since the epithelia is exposed to the same oscillating shear stress conditions during treatment.

### Methods

Three subjects with negative ear pressure were treated using a therapeutic massager. Subjects A and B were treated with the Sun Ancon ‘Chi Machine’ marketed by HsinTen and Subject C was treated with the ‘Chi Vitalizer’ USJ106 marketed by US Jaclean. Both machines were set to oscillate at 140 CPM and have similar displacement. Middle ear pressure, as indicated by Tympanometric Peak Pressure (TPP), was measured before and after treatment using an Earscan Acoustic Impedance Instrument manufactured by Micro Audiometrics Corp. Data was collected over multiple days for the three subjects.

The first subject (Subject A) is a 49 year old male who is 5 feet 11 inches tall and weighs 220 pounds with chronic otitis media in his right ear. This subject has otitis media with effusion in the left ear and therefore the left ear did not register any tympanometric pressure readings. TPP was measured for the right ear on 5 days over a 7 day period. During each of the 5 days, Subject A was treated on the therapeutic massager set at 140 CPM for 30 minutes.

The second subject (Subject B) is a 49 year old female who is 5 feet 3 inches tall and weighs 125 pounds has chronic rhinitis and otitis media in both ears. TPP data was measured on 4 days over an 8 day period. During each of the 4 days, Subject B was treated on the therapeutic massager set at 140 CPM for 30 minutes.

The third subject (Subject C) is a 53 year old female who is 5 feet tall and weighs 125 pounds who was experiencing temporarily blocked sinuses and otitis media in both ears because of a cold. TPP was measured on 4 days over an 8 day period. During each of the 4 days, Subject C was treated on the therapeutic massager set at 140 CPM for 15 minutes.

Middle ear pressure for each subject was analyzed using paired t-test.

To assess the typical degree of movement in the upper respiratory tract, a fourth subject was videotaped while using the ‘Chi Vitalizer’ therapeutic massager and the video was then digitized to show the displacement in the forehead across and along the body in the coronal plane. This fourth subject is 5 feet 6 inches tall and weighs about 110 pounds.

### Results

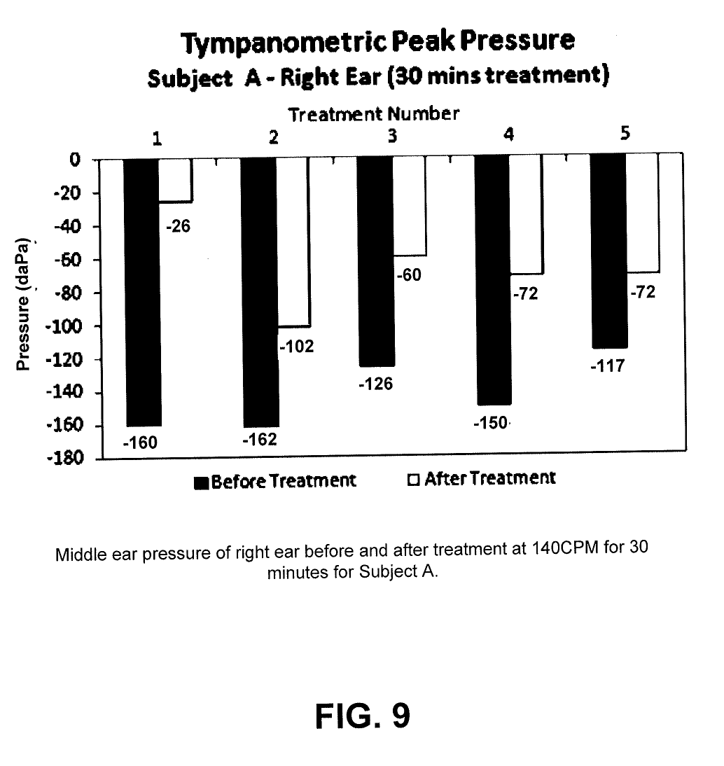

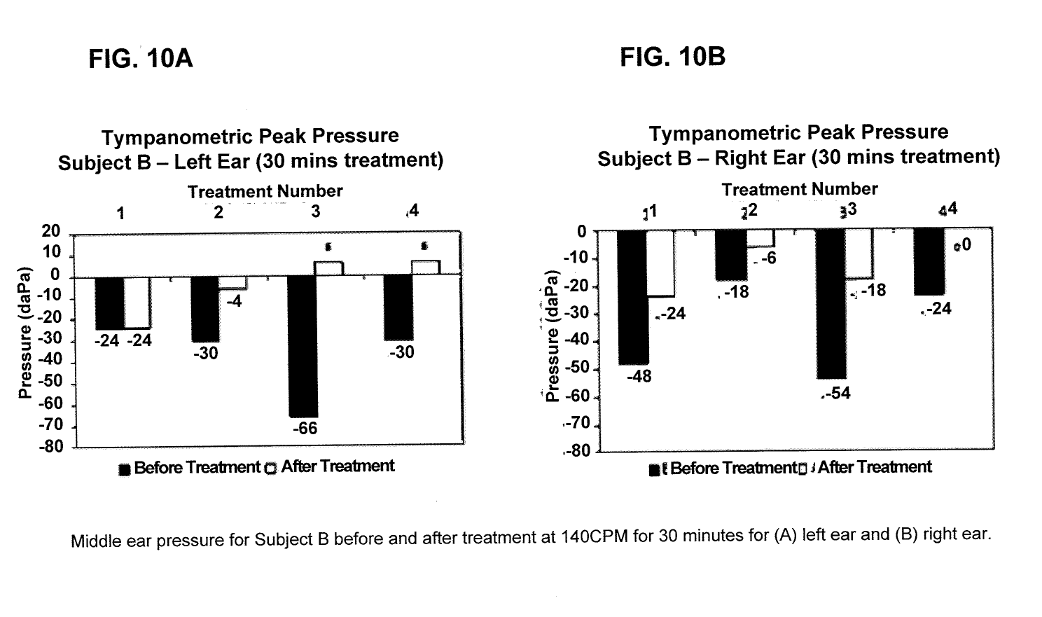

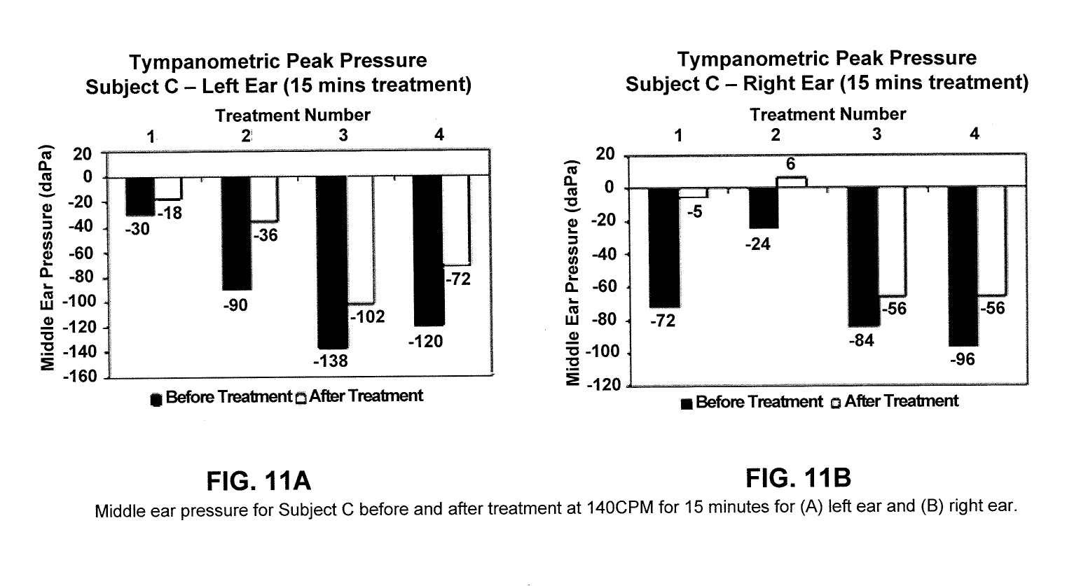

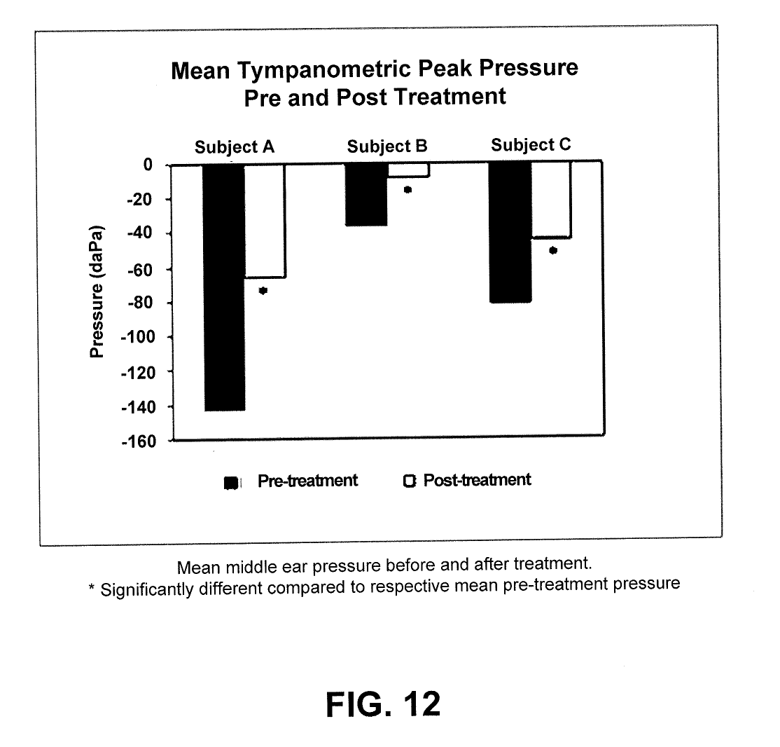

As shown in FIGS. 9-11, middle ear pressures, as indicated by TPP, increased after treatment for all 3 subjects. The post-treatment middle ear pressure was significantly higher than the pre-treatment values, with p values of 0.007, 0.007, and 0.001, respectively, for Subjects A, B, and C. Mean pre- and post-treatment TPP for individual subjects are shown in FIG. 12. In all cases, subjects reported feeling ‘popping’ or ‘slight movement’ in their ears during treatment and in some cases, for hours and days after treatment was completed.

The increase in TPP after treatment demonstrated that the mild oscillating shear stress generated in the upper respiratory area increased MCC sufficiently to cause the Eustachian tube to open intermittently. Since the entire respiratory epithelium is subjected to the same oscillating shear stress, this improvement of MCC in the middle ear is reflective of enhanced MCC along the entire respiratory tract.

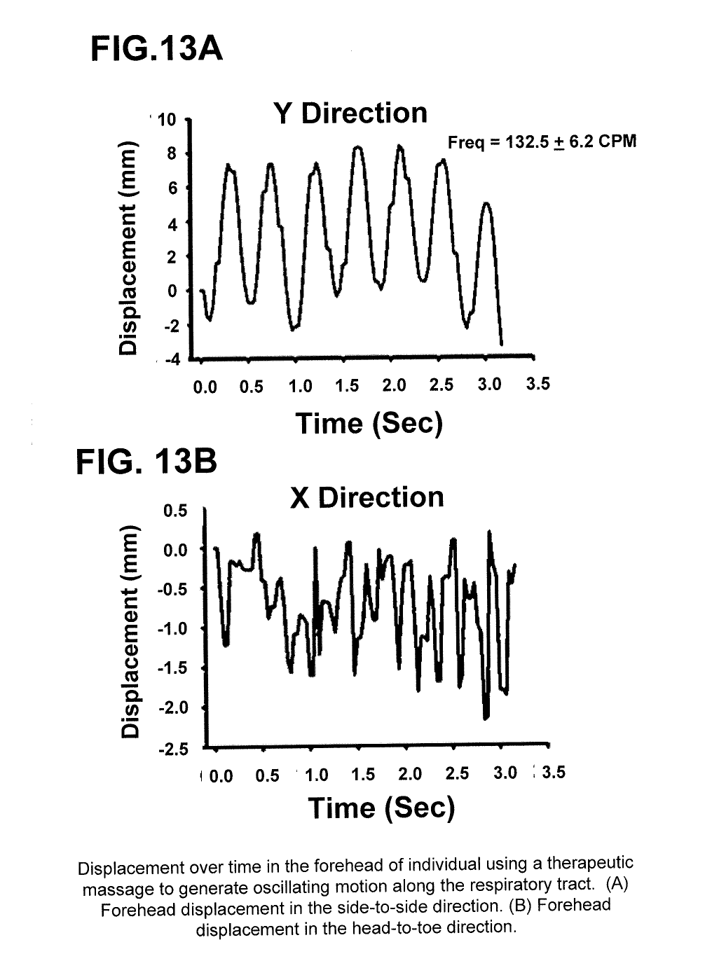

FIG. 13 shows that by applying an oscillating motion to the lower extremity of the body of a subject while lying down, the oscillating motion is transmitted to the head, thereby creating oscillating shear stress along the entire respiratory tract. In this case, the displacement generated by an exemplary apparatus or device such as the ‘Chi Vitalizer’ on this subject was observed in two directions along the coronal plane. For example, displacement of about 9-10 mm was observed in the side-to-side, i.e., ear-to-ear direction and displacement of 1-2 mm was observed in the longitudinal, i.e., head-to-toe direction. As such, the methods and apparatuses described herein find utility in preventing or treating diseases such as CF, COPD, allergic and non-allergic rhinitis, chronic sinusitis, otitis media, and any other condition where mucociliary clearance needs to be improved.

### Statistical Analysis

Statistical Analysis of Tympanometric Peak Pressure:

Results for: Subject A
Paired T-Test and CI: Post, Pre
Paired T for Post - Pre

| | N | Mean | StDev | SE Mean |
|---|---|---|---|---|
| Post | 5 | −66.4 | 27.4 | 12.3 |
| Pre | 5 | −143.0 | 20.4 | 9.1 |
| Difference | 5 | 76.6 | 34.2 | 15.3 |

95% CI for mean difference: (34.1, 119.1)
T-Test of mean difference = 0 (vs not = 0): T-Value = 5.01 P-Value = 0.007

Results for: Subject B
Paired T-Test and CI: Post, Pre
Paired T for Post - Pre

| | N | Mean | StDev | SE Mean |
|---|---|---|---|---|
| Post | 8 | −8.25 | 12.40 | 4.38 |
| Pre | 8 | −36.75 | 17.10 | 6.05 |
| Difference | 8 | 28.50 | 21.21 | 7.50 |

95% CI for mean difference: (10.77, 46.23)
T-Test of mean difference = 0 (vs not = 0): T-Value = 3.80 P-Value = 0.007

Results for: Subject C
Paired T-Test and CI: Post, Pre
Paired T for Post - Pre

| | N | Mean | StDev | SE Mean |
|---|---|---|---|---|
| Post | 8 | −45.0 | 37.4 | 13.2 |
| Pre | 8 | −81.8 | 39.7 | 14.0 |
| Difference | 8 | 36.75 | 18.27 | 6.46 |

95% CI for mean difference: (21.48, 52.02)
T-Test of mean difference = 0 (vs not = 0): T-Value = 5.69 P-Value = 0.001

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference.

What is claimed is:

1. A method for increasing mucociliary clearance of a subject, said method comprising:
providing an oscillating lateral motion to said subject positioned in a supine position on a flat surface, wherein said oscillating lateral motion is applied at a frequency of about 60 to about 200 cycles per minute; and
providing said oscillating lateral motion for a time period of about 2 to about 60 minutes.

2. The method of claim 1, wherein said method clears mucus in at least one member selected from the group consisting of the Eustachian tube, middle ear, sinus cavity, nasal cavity, trachea, bronchi, and bronchioles.

3. The method of claim 1, wherein said oscillating lateral motion is applied to a part of each leg of said subject.

4. The method of claim 3, wherein said oscillating lateral motion is applied to each ankle of each leg of said subject.

5. The method of claim 3, wherein said oscillating lateral motion is applied to each knee of each leg of said subject.

6. The method of claim 3, wherein said oscillating lateral motion is applied to each calf of each leg of said subject.

7. The method of claim 3, wherein said oscillating lateral motion is applied to each thigh of each leg of said subject.

8. The method of claim 3, wherein said oscillating lateral motion is applied to the each hip of each leg of said subject.

9. The method of claim 1, wherein said oscillating lateral motion is applied to the torso of said subject.

10. The method of claim 1, wherein said oscillating lateral motion is at a frequency of about 90 to about 180 cycles per minute.

11. The method of claim 10, wherein said oscillating lateral motion is at a frequency of about 110 to about 160 cycles per minute.

12. The method of claim 10, wherein said oscillating lateral motion is at a frequency of about 130 to about 150 cycles per minute.

13. The method of claim 10, wherein said oscillating lateral motion is at a frequency of about 140 cycles per minute.

14. The method of claim 1, wherein said oscillating lateral motion is applied for a time period of about 10 to about 50 minutes.

15. The method of claim 14, wherein said oscillating lateral motion is applied for a time period of about 20 to about 45 minutes.

16. The method of claim 14, wherein said oscillating lateral motion is applied for a time period of about 25 to about 35 minutes.

17. The method of claim 1, wherein said oscillating lateral motion provides a side-to-side twisting motion to the hips of said subject.

18. The method of claim 1, wherein said oscillating lateral motion provides a side-to-side twisting motion to the torso of said subject.

19. The method of claim 1, wherein said oscillating lateral motion provides a side-to-side twisting motion to the head of said subject.

20. The method of claim 1, wherein said oscillating lateral motion translates into a lateral displacement of about 5 mm to about 20 mm of the forehead of said subject.

21. The method of claim 20, wherein said oscillating lateral motion translates into a lateral displacement of about 8 mm to about 14 mm of the forehead of said subject.

22. The method of claim 1, wherein said oscillating lateral motion translates into a longitudinal displacement of about 0.5 mm to about 5 mm of the forehead of said subject.

23. The method of claim 22, wherein said oscillating lateral motion translates into a longitudinal displacement of about 1 mm to about 2 mm of the forehead of said subject.

24. The method of claim 1, wherein said method further comprises a health care provider performing an assessment of the amount of mucociliary clearance after expiry of the time period.

25. The method of claim 1, wherein said oscillating lateral motion generates oscillating shear stress in said subject's respiratory system.

26. The method of claim 25, wherein said oscillating lateral motion generates oscillating shear stress in a range of about 0.01 to about 10 dynes per cm².

27. The method of claim 25, wherein said oscillating lateral motion generates oscillating shear stress in a range of about 0.1 to about 5 dynes per cm².
